(19) United States
(12) Patent Application Publication
(10) Pub. No.: US 2007/0264401 A1
(43) Pub. Date: Nov. 15, 2007

(54) Beverage preservatives

(76) Inventors: Peter J. Taormina, Marietta, GA (US); Peter G. Simpson, Alpharetta, GA (US); Esteban A. Bertera, Dunwoody, GA (US); Evangelia Komitopoulou, Guildford (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/641,882

(22) Filed: Dec. 20, 2006

Related U.S. Application Data
(60) Provisional application No. 60/799,641, filed on May 12, 2006.

(51) Int. Cl. A23L 3/34

(52) U.S. Cl. 426/532

(57) ABSTRACT

The present invention is directed to at least one saponin-comprising extract that can be used as a preservative and/or used as a part of a preservative system to delay, maintain, inhibit and/or reduce growth of microorganisms chosen from molds, yeasts and/or bacteria, in beverages or foods.

This application claims the benefit of U.S. Provisional Application No. 60/799,641, filed May 12, 2006, which is incorporated by reference herein in its entirety for any purpose.

The present invention is directed to preservatives and to compositions comprising at least one saponin-comprising extract used as a preservative in an amount effective to inhibit and/or reduce growth of at least one microorganism chosen from molds, yeasts, and bacteria. In addition, the present invention is directed to a preservative system comprising at least one saponin-comprising extract and at least one additional preservative, wherein the preservative system exhibits enhanced inhibition and/or reduced growth of at least one microorganism chosen from molds, yeasts and bacteria when compared to the at least one saponin-comprising extract or at least one additional preservative used alone.

Microbial spoilage of beverages is a-concern in the beverage industry today. Beverages have varying degrees of sensitivity to microbiological spoilage depending on intrinsic factors of the beverage such as pH, nutrient content (e.g., juice, vitamin, or micronutrient content), carbonation level, Brix, water quality (e.g., alkalinity and/or hardness), and preservatives. Spoilage events-occur when microorganisms are able to overcome the beverage's intrinsic factors and grow. The microorganisms' ability to-overcome these hurdles can be influenced by, among other things, initial contamination level, temperature and package integrity of the beverage against carbonation loss, i.e., in the case of carbonated soft drinks.

Microbiological spoilage can result from one or more yeasts, bacteria, and/or mold microorganisms. For example, yeasts and bacteria are capable of spoiling carbonated and non-carbonated beverages such as fruit drinks, teas, coffees, enhanced waters, etc. The ability of yeasts and certain bacteria to grow anaerobically enables their growth in carbonated beverages, while molds are restricted to aerobic metabolism, and therefore do not grow. See Stratford, M. et al., Fruit Juices, Fruit Drinks, and Soft Drinks, In The Microbiological Safety & Quality of Food (eds. B. M. Lund, T. C. Baird-Parker, and G. W. Gould, Aspen Publishers 2000). Typically, spoilage by yeasts manifests itself as fermentation with gas and ethanol production, as well as sedimentation, off-flavors and odors, and loss of cloud or emulsion stability. Bacteria tend to produce off-flavors and odors with associated sedimentation. On the other hand, molds may survive but generally are not capable of growth in low oxygen environments and thus, do not spoil carbonated soft drinks except when carbonation is diminished. Mold spoilage of non-carbonated beverages, however, can occur and may be evident after mold mycelial growth, by floating globules, clumps or surface pellicles.

Although yeasts such as Saccharomyces, Zygosaccharomyces, Candida, and Dekkera spp. are often responsible for spoilage incidents in common beverages, acidophilic bacteria such as Lactobacillus, Leuconostoc, Gluconobacter, and Zymomonas spp. and molds like Penicillium and Aspergillus spp. can also spoil cold-filled beverages. Spores of acidophilic, thermophilic bacteria such as Alicyclobacillus spp. and heat resistant mold spores of Byssochlamys and Neosartorya spp. can survive pasteurization and may spoil non-carbonated hot-filled products such as sport drinks and teas. Packaged waters are susceptible to growth by molds as well.

Protection against microbiological spoilage of beverages can be achieved using chemical preservatives and/or processing techniques such as hot filling, tunnel pasteurization, ultra-high temperature treatment (UHT) or pasteurization followed by aseptic packaging, and/or pasteurization followed by chilling the beverage. Generally, beverages with a pH<4.6 can be chemically preserved, heat processed, and filled into packages such that the product is not re-contaminated. For example, process techniques such as cold filling with chemical preservatives or pasteurization followed by cold-filling may be used to preserve this type of beverage. In a similar manner, this same beverage may be processed using non-preserved techniques such as hot filling, tunnel pasteurization, pasteurization followed by aseptic filling or even requiring the beverage to be chilled, i.e., under refrigeration following the pasteurization step. Beverages having a pH≧4.6 must be processed such that spores are destroyed using ultra-high temperatures followed by aseptic filling into packages or retorting sealed packages of product.

Current preservation systems for acidic, shelf-stable carbonated and non-carbonated soft drinks rely on weak acid preservatives (e.g., benzoic and/or sorbic acid). Benzoic and sorbic acids (and salts thereof) effectively inhibit yeast, bacteria, and molds with some exceptions. Weak acids in beverages exist in equilibrium between their dissociated and undissociated forms which is dependent upon the dissociation constant of the acid (pKa) and the beverage pH. The pKa for benzoic acid is 4.19 and the pKa of sorbic acid is 4.76. A beverage pH below the pKa of the particular acid pushes the equilibrium towards the undissociated form. The undissociated form is more efficacious against microorganisms, and therefore, weak acid preservatives may be most effective in the low pH range. The preservation properties of weak acids may be enhanced by the addition of chelating compounds to the beverage. For example, common chelating compounds added to beverages include calcium disodium ethylenediaminetetraacetic acid (EDTA) or one or more of the polyphosphates, such as sodium hexametaphosphate (SHMP). In high nutrient non-carbonated products, such as those beverages containing juice, vitamins, and/or minerals, the weak acids are more likely to exert inhibition if used in conjunction with preservative enhancers.

Weak acid preservation systems, however, have limitations. Genetic adaptation and subsequent resistance by microorganisms may be one of the biggest concerns. See Piper, P. et al., Weak Acid Adaptation: The Stress Response that Confers Yeasts with Resistance to Organic Acid Food Preservatives, 147 Microbiol. 2635-2642 (2001). Certain yeasts, such as Z. bailii, Z. bisporus, C. krusei, and S. cerevisiae, have specific genes that enable them to resist the weak acid preservatives and grow, despite their presence and regardless of the co-presence of EDTA or SHMP. Some bacteria, such as Gluconobacter spp., are also thought to be preservative resistant. The levels of weak acids necessary to overcome this resistance have been shown to be far beyond regulatory limits on use levels. Spoilage of preserved teas, juice-containing beverages, and carbonated beverages is commonly due to preservative-resistant yeasts.

Weak acids are also known to impart a throat or mouth burn when used at high levels. Although there are certain shelf-stable beverages where this may be acceptable, often this sensory perception is considered negative. In addition, non-government organizations and also some international government agencies have raised concerns regarding the use of weak acid preservatives in beverages and foods.

In addition, the other process techniques for low acid beverages (i.e. with a pH≧4.6) have limitations. Such low acid beverages should be thermally treated to sufficiently destroy spores of Clostridium botulinum and Bacillus cereus. Examples of such processes include UHT and retort. Even after such processing, product should be handled in a way to prevent post-processing contamination. Research, however, suggests that there may still be various strains of sporeforming microorganisms that can survive these different processing techniques. To that end, these processing techniques may not eliminate the potential for spoilage.

Natural preservatives having the capability of not only preserving beverages, but also being able to impart health benefits may be desirable for consumers. Preservatives that could be labeled as natural could also eliminate hot-fill requirements for unpreserved shelf-stable preservative free beverages. Thus, it would be desirable to provide a natural preservative and/or a preservative system that inhibits growth of microorganisms to solve at least one of the above-mentioned limitations in the art.

The present inventors have discovered that at least one saponin-comprising extract can be used as a preservative and/or used as a part of a preservative system to inhibit and/or reduce growth of microorganisms chosen from molds, yeasts, and/or bacteria, in beverages and/or foods.

In one embodiment, the present invention is directed to a beverage or food preservative of at least one saponin-comprising extract, wherein the at least one extract is present in an effective amount to inhibit and/or reduce growth of microorganisms chosen from molds, yeasts, and bacteria.

In another embodiment, the present invention is directed to a preservative system comprising at least one saponin-comprising extract and at least one additional preservative, wherein the preservative system exhibits enhanced inhibition and/or reduced growth of at least one microorganism chosen from molds, yeasts and bacteria when compared to the at least one saponin-comprising extract or the at least one additional preservative used alone.

It is to be understood that both the foregoing general description and the following detailed description are exemplary and explanatory only and are not restrictive of the present invention, as claimed.

### BRIEF DESCRIPTION OF THE DRAWINGS

FIG. 1 is a bar graph showing the maximum populations of yeast reached within the time period from day 0 to day 28 in weak acid preserved or Yucca extract preserved malt extract broth and corresponds to data presented in Tables TWO and FOUR.

FIG. 2 is a bar graph showing the maximum populations of mold reached within the time period from day 0 to day 28 in weak acid preserved or Yucca extract preserved malt extract broth and corresponds to data presented in Tables TWO and FOUR.

FIG. 3 is a bar graph showing the maximum populations of acidophilic bacteria reached within the time period from day 0 to day 28 in weak acid preserved or Yucca extract preserved malt extract broth and corresponds to data presented in Tables TWO and FOUR.

FIG. 4 is a bar graph showing the maximum populations of sporeforming bacteria reached within the time period from day 0 to day 28 in weak acid preserved or Yucca extract preserved malt extract broth and corresponds to data presented in Tables TWO and FOUR.

FIG. 5 is a bar graph showing the maximum populations of yeast reached within the time period from day 0 to day 28 in weak acid preserved or Yucca extract preserved sucrose solutions and corresponds to data presented in Tables FIVE and NINE.

FIG. 6 is a bar graph showing the maximum populations of yeast reached within the time period from day 0 to day 28 in weak acid preserved or Quillaja extract preserved sucrose solutions and corresponds to data presented in Tables SEVEN and NINE.

FIG. 7 is a bar graph showing the maximum populations of molds reached within the time period from day 0 to day 28 in weak acid preserved or Yucca extract preserved sucrose solutions and corresponds to data presented in Tables FIVE, and NINE.

FIG. 8 is a bar graph showing the maximum populations of acidophilic bacteria reached within the time period from day 0 to day 28 in weak acid preserved or Yucca extract preserved sucrose solutions and corresponds to data presented in Tables FIVE, SIX, and NINE.

FIG. 9 is a bar graph showing the maximum populations of acidophilic bacteria reached within the time period from day 0 to day 28 in weak acid preserved or Quillaja extract preserved sucrose solutions and corresponds to data presented in Tables SEVEN, EIGHT, and NINE.

FIG. 10 is a bar graph showing the maximum populations of sporeforming bacteria reached within the time period from day 0 to day 28 in weak acid preserved or Yucca extract preserved sucrose solutions and corresponds to data presented in Tables FIVE, SIX, and NINE.

FIG. 11 is a bar graph showing the maximum populations of sporeforming bacteria reached within the time period from day 0 to day 28 in weak acid preserved or Quillaja extract preserved sucrose solutions and corresponds to data presented in Tables SEVEN, EIGHT, and NINE.

The present invention is directed to a preservative composition comprising at least one saponin-comprising extract, wherein the preservative composition achieves microbial stability of at least one microorganism chosen from mold, yeast and bacteria in a beverage or food. As a result, the beverage and/or food composition does not require further processing techniques such as syrup pasteurization, beverage hot filling, or the incorporation of traditional levels of weak-acid preservatives into the beverage in order to obtain inhibition and/or reduction in microbial growth. Because the beverage or food composition may not require traditional levels of preservatives and may use a natural preservative, the compositions of the present invention can minimize off-flavors associated with the high-levels of preservatives, can reduce dependence on the traditional preservative systems leading to antimicrobial resistance, can use at least one natural preservative, and can reduce the level of traditional preservatives.

The foregoing general description and the following detailed description of the present invention are described, for purposes of example, in connection with a beverage composition. The present inventors contemplate that the embodiments described herein are capable of use in other compositions such as a food, e.g., food for human consumption and animal consumption, cosmetics, and pharmaceutical compositions. Thus, it is intended that the present invention cover modifications and variations of the invention, provided that they come within the scope of the appended claims and their equivalents.

It has been surprisingly and unexpectedly discovered that at least one-saponin-comprising extract can be used as a preservative in e.g., a beverage, against microbiological proliferation and as a result, maintains the microbiological stability of the beverage after an initial inoculation with microorganisms chosen from mold, yeast and bacteria. As used herein, “microbiological stability” or “microbial stability” or “microbial inhibition” refers to no significant increase or decline in a microbial inoculum in a beverage or model beverage from day 0 to day 28, i.e., no greater or equal to 1.0 log increase or less than a 1.0 log increase to remain at stasis, or no greater than 1.0 log reduction of microorganism viability from day 0 to day 28. As used herein, “extended microbial stability” or “extended microbial inhibition” refers to no significant increase or decline in viability of a microbial inoculum in a beverage or model beverage from day 0 to day 60, i.e., no greater or equal to 1.0 log increase or less than a 1.0 log increase to remain at stasis, or no greater than 1.0 log reduction of microorganism viability from day 0 to day 60. “Microbial reduction” refers to greater than a 1.0 log CFU/ml lower population of a microbial inoculum within 28 days in comparison to the day 0 time point or known inoculum level. “Enhanced microbial reduction” refers to complete reduction of microbial inocula within 28 or 60 days.

As used herein, the term “beverage” or “beverage composition” refers to a liquid drink that is appropriate for human or animal consumption. Mention may be made, of beverages, but not limited to, for example, energy drinks, flavored water, fruit smoothies, sport drinks, fruit juices (e.g., juice drinks and full strength fruit juice), carbonated sodas/juices, shakes, protein drinks (e.g., dairy, soy, rice or other), meal replacements, drinkable dairy yogurts, drinkable soy yogurts, teas, coffees, cola drinks, fortified waters, low acid beverages as defined in 21 C.F.R §113, acidified beverages as defined in 21 C.F.R. §114, syrups, cordials, dilutables such as squashes, health drinks, functional beverages (e.g., nutraceuticals), nectars, tonics, horchata (i.e., vegetable and/or rice components made into a beverage), frozen carbonated beverages and frozen uncarbonated beverages.

As used herein, “food” refers at least to an edible food product, such as, a solid or semi-solid food stuff. Mention may be made of food products such as, but not limited to, frozen ice cream or desserts, yogurt, baby/children foods, fruit leathers/roll ups, dairy yogurts, soy yogurts, granola bars/snacks, crackers, fruit bars, energy bars, nutritional bars, toothpastes, and any other edible composition that can be spoiled as a result of microorganism contamination.

Saponin-Comprising Extract

The present inventors discovered that certain levels of at least one saponin-comprising extract can be used as a preservative in a beverage or a food product and further, in combination with at least one additional preservative other than the at least one saponin-comprising extract. Saponins are a group of naturally occurring glycosides, predominantly found in the plant kingdom. They comprise a non-carbohydrate aglycone coupled to sugar chain units. Saponins are divided in two groups: steroidal and triterpene saponins. Over 100 steroidal and an even higher number of triterpene saponins have been so far identified. K. Hostettmann, & A. Marston, Saponins (Cambridge University Press 1995).

A saponin-comprising extract may be derived from, e.g., but not limited to, edible plants such as soya, beans, peas, oat, Solanum and Allium species, tomato, asparagus, tea, peanut, spinach, sugar beet, yam, blackberry, liquorice root, primula root, senega root, Quillaja, Yucca, and Gyposphila. Commercially available saponin-comprising extracts generally are derived from Yucca, such as Yucca schidigera and Quillaja, such as Quillaja saponaria.

Yucca schidigera is a plant that grows wild in the southwestern part of the United States and the northern part of Mexico. Quillaja saponaria is a tree found in South America such as in the dry regions of Chile. Studies contend that saponins are generally not absorbed in the digestive tract and thus, do not lead to serious toxicological problems, while oral toxicity of saponins has been estimated to be low. Price et al., Chemistry and Biological Significance of Saponins in Foods and Feedingstuffs, 26 CRC Crit. Rev. Food Sci. Nutr. 27-135 (1987). According to the present invention, the at least one saponin-comprising extract may be derived from a single source or from multiple sources. Further, the at least one saponin-comprising extract can be chosen from steroidal and triterpene saponins, and mixtures thereof.

Saponin-comprising extracts are known to have certain beneficial characteristics and uses such as foaming agents as used in U.S. Pat. No. 4,986,994, surfactants as used in U.S. Pat. Nos. 5,503,766 and 6,214,349, food flavorants as used in U.S. Pat. No. 5,804,239, agents in sanitary wipes as used in U.S. Pat. No. 6,734,157, and therapeutic agents as used in U.S. Publication No. 2004/0096527. In addition, Japanese Publication No. 2003009832 teaches a keeping improver particularly directed to inhibiting sprout growth of bacterial spores that contains an extract from saponin vegetation chosen from Sapindus mukurossi, a horse chestnut and asparagus as active agents.

Although saponin-comprising extracts have been utilized in different capacities, the present inventors surprisingly discovered that at least one saponin-comprising extract can be used as a preservative in replacement of traditional preservative systems and/or can be used in conjunction with known preservatives to maintain microbial stability, microbial reduction, or enhanced stability or reduction or even to enhance microstability and may be used to reduce levels of traditional preservative systems. This has been demonstrated by greater death of yeast cells in beverages and beverage systems (e.g., 1.0 log and/or 2.0 log CFU/ml reductions within 28 days) than exhibited by using traditional weak-acid preservative systems, inhibition of preservative-resistant yeasts (Zygosaccharomyces and Candida krusei) that grew in weak-acid preserved beverages or beverage systems without saponins, reduction of mold spores or inhibition of visible mold growth, and inhibition of bacterial proliferation (less than 1.0 log CFU/ml increase within 28 days) in these same systems.

It is postulated that antimicrobial properties of saponins stem from the interaction of saponin molecules with membrane sterols, which comprise a significant portion of the cell membrane of e.g., yeasts. Even though bacterial membranes are low in cholesterol, making them resistant to the effects of saponins, it has been shown that the fatty acid composition of bacterial cell membranes can also be a target for saponins. The major effect of saponins on bacteria is disruption of membranes and leakage of protein and enzymes. Hoagland et al., Effect of Alfalfa Saponins on Rhizosphere Bacteria, 86 Phytopathology S97 (1996); Zablotowicz et al., Effects of Saponins on the Growth and Activity of Rhizosphere Bacteria, in Saponins Used in Food and Agriculture 83-95 (G. R. Wailer & K. Yamasaki eds. 1996). The interaction with membrane sterols, proteins and phospholipids seems to be at least one of the possible mechanisms of the antibacterial as well as the antifungal activity of saponins.

Provided below in Table ONE are non-limiting examples of various types of microorganism such as molds, yeasts and bacteria, that commonly contaminate a beverage. Aspergillus spp. and Penicillium spp. represent common mold genera that can readily grow in non-carbonated beverages such as juice drinks and enhanced waters if not controlled by preservation or heating. Byssochlamys spp. and Neosartorya spp. are examples of heat resistant molds that survive pasteurization and grow in, for example, unpreserved isotonic sport drinks and teas. The yeasts, Zygosaccharomyces spp., Saccharomyces spp., and Candida spp., can be problematic to acidic shelf stable beverages in part due to their potential resistance to sorbic and benzoic acid. Dekkera spp. are a genus of yeasts that are uniquely tolerant to high levels of carbonation, and thus can grow in and spoil carbonated beverages. Lactobacillus spp. and Gluconobacter spp. are acidophilic bacteria that can spoil non-carbonated beverages. The genus Alicyclobacillus spp. is a spore-forming bacterium that can survive pasteurization and grow at elevated temperatures of beverages such as isotonic sport drinks and juices. Bacillus spp. and Clostridium spp. are sporeforming bacteria that may survive mild pasteurization treatments and spoil low-acid food and beverage products.

TABLE ONE
Examples of microorganisms that may grow in and cause spoilage of
beverages.

| Microorganism Type | Name |
|---|---|
| Mold | Aspergillus spp. |
| | Penicillium spp. |
| | Byssochlamys spp. |
| | Neosartorya spp. |
| Yeast | Candida spp. |
| | Debaryomyces spp. |
| | Dekkera spp. |
| | Pichia spp. |
| | Saccharomyces spp. |
| | Zygosaccharomyces spp. |
| Bacteria | Alicyclobacillus spp. |
| | Gluconobacter spp. |
| | Lactobacillus spp. |
| | Leuconostoc spp. |
| Bacteria in Low Acid Foods & | Bacillus spp. |
| Beverages | Clostridium spp. |

Saponins are naturally occurring compounds and can be found in a variety of plants. For example, peanuts have from 1.3% to 1.6%, spinach root has about 4.7%, horse chestnut has about 3% to 6%, guar has about 10%, and asparagus has about 1.5% of saponins. Price et al., The Chemistry and Biological Significance of Saponins in Foods and Feeding Stuffs, 26 CRC Crit. Rev. Food Sci. Nutr. 27-135 (1987). Despite those naturally occurring saponins in many plants used as human food, there are only two plant sources that are approved as food additives. The two are: Quillaja saponaria (triterpene-saponins) and Yucca schidigera (steroidal-saponins). These saponin-comprising extracts are currently regarded as generally recognized as safe (GRAS) products and are permitted to be used in food and beverages in the United Kingdom and United States and other regions. Moreover, Yucca extracts generally contain about 10% of dry weight saponins. Oleszek, Wieslaw, et al., Steriodal Saponins of Yucca schidigera Roezel, 49 J. Agric. Food Chem. 4392 (2001).

According to the present invention, the antimicrobial properties of the saponin-comprising extract are harnessed as a preservative in compositions such as beverages by using an effective amount of the saponin-comprising extract, wherein the preservative achieves microbial stability of at least one microorganism chosen from mold, yeast and bacteria in a beverage or a food. The effective amount of the saponin-comprising extract can depend on the nature of the beverage. For example, the saponin-comprising extract may be present in the beverage product in an amount ranging from about 50 ppm to about 20,000 ppm such as from about 250 ppm to about 5000 ppm in high-nutrient (e.g., juice, vitamin, nitrogen, etc.) beverages, or for example from about 100 ppm to about 1000 ppm in low nutrient beverages (e.g., beverages lacking vitamin(s), low levels of nitrogen, etc., and about <3% juice), and further for example, from about 250 ppm to about 1000 ppm such as 250 ppm to 750 ppm in low acid beverages.

Initially, the inventors examined strains of various microorganisms in a malt extract broth to evaluate whether the at least one saponin-comprising extract, e.g., a crude extract of Yucca schidigera, exhibited antimicrobial activity against these microorganisms and to determine minimum inhibitory concentrations. Malt extract broth was chosen because it is commonly used in the beverage industry for enumeration of spoilage microorganisms. The malt extract broth was adjusted to pH 5.0 with citric acid. Although some antimicrobials may not exert maximum, much less any, effect at high pH (in this case, pH 5), the objective was to determine minimum inhibitory levels of the saponin-comprising extract under near-ideal conditions for the growth of the microorganisms. This provided a worst-case scenario for testing the effectiveness of the antimicrobials, and the inhibition of microorganisms in acidic beverages can safely be expected to be greater (i.e., less growth or more death of microbial cells or spores) due to lower pH and fewer nitrogenous biomolecules. The experiments were replicated thrice and average log populations in samples over time were tabulated. As provided in Tables TWO and THREE below, the saponin-comprising extract demonstrated varying degrees of growth inhibition/reduction against a range of microorganisms.

The data presented below in Tables TWO through THREE utilized stock solutions of 20 ml/L and 10 ml/L of Yucca or Quillaja extract prepared by aseptically adding 20 ml or 10 ml of Yucca extract to 980 ml to 990 ml of a malt extract broth and granular acid to adjust the pH to about 5.0. Antimicrobial assays for each saponin-comprising extract were separately set up using working solutions prepared at final Yucca concentrations of 0.1, 0.25, 0.5,1 and 2 ml/L, as follows: for a 0.1 ml/L (100 ppm) solution, 0.1 ml from the 10 ml/L stock into 9.9 ml of the broth; for 0.25 ml/L (250 ppm) solution, 0.25 ml of the 10 ml stock in 9.75 ml of the broth; for the 0.5 ml/L (500 ppm) solution, 0.25 ml of the 20 ml/L stock in 9.75 ml of the broth; for the 1 ml/L (1000 ppm) solution, 0.5 ml of the 20 ml/L stock into 9.5 ml of the broth; and for the 2 ml/L (2000 ppm) solution, 1 ml of the 20 ml stock in 9.0 ml of the broth. It should also be noted that because those solutions were prepared based on a volume/volume percentage, the ppm values indicated in parenthesis and in the tables should be multiplied by the density of the undiluted crude extracts in order to obtain a more accurate ppm value. The density of the undiluted extracts was about 1.22 g/ml. Thus, for the 100 ppm solution, the ppm value was actually 122 ppm. Likewise, the 250 ppm solution should be 305 ppm, the 500 ppm solution should be 610 ppm, the 1000 ppm solution should be 1220 ppm, and the 2000 ppm solution should be 2440 ppm.

Table FOUR summarizes malt extract broth inoculated with similar microorganisms found in Tables TWO and THREE but used a traditional preservative system, i.e., benzoate/sorbate/EDTA.

TABLE TWO
Evaluation of Yucca extract against different molds, yeasts, and bacteria in malt extract broth at pH
5.0, 25° C. Levels of microorganisms are shown in mean log₁₀ colony forming units (CFU) per milliliter ± standard
deviation (SD).

| | Time | Yucca extract concentrations (ppm) | | | | | |
|---|---|---|---|---|---|---|---|
| Microorganism | (days) | 0 | 100 | 250 | 500 | 1000 | 2000 |
| YEAST | 0 | 3.01 ± 0.12 | 3.39 ± 0.13 | 3.40 ± 0.01 | 3.42 ± 0.18 | 3.31 ± 0.17 | 3.21 ± 0.14 |
| Zygosaccharomyces | 7 | 7.36 ± 0.10 | 2.48 ± 0.12 | <1.00 | <1.00 | <1.00 | <1.00 |
| bailii | 14 | 7.16 ± 0.13 | 7.40 ± 0.53 | 2.30 ± 0.25 | <1.00 | <1.00 | <1.00 |
| | 21 | ND | ND | 3.36 ± 0.18 | <1.00 | <1.00 | <1.00 |
| | 28 | ND | ND | 2.14 ± 0.47 | <1.00 | <1.00 | <1.00 |
| | 60 | ND | ND | <1.00 | <1.00 | <1.00 | <1.00 |
| YEAST | 0 | 3.21 ± 0.06 | 3.41 ± 0.18 | 3.51 ± 0.04 | 3.47 ± 0.14 | 3.46 ± 0.18 | 3.35 ± 0.27 |
| Dekkera bruxellensis | 7 | 7.20 ± 0.06 | <1.00 | <1.00 | <1.00 | <1.00 | <1.00 |
| | 14 | 7.15 ± 0.09 | <1.00 | <1.00 | <1.00 | <1.00 | <1.00 |
| | 21 | ND | 1.47 ± 0.72 | <1.00 | <1.00 | <1.00 | <1.00 |
| | 28 | ND | 7.30 ± 0.89 | <1.00 | <1.00 | <1.00 | <1.00 |
| | 60 | ND | ND | <1.00 | <1.00 | <1.00 | <1.00 |
| YEAST | 0 | 3.12 ± 0.06 | 3.61 ± 0.03 | 3.56 ± 0.05 | 3.43 ± 0.16 | 3.47 ± 0.06 | 3.30 ± 0.09 |
| Saccharomyces | 7 | 6.74 ± 0.10 | 6.47 ± 0.29 | 6.35 ± 0.25 | <1.00 | <1.00 | <1.00 |
| cerevisiae | 14 | 7.12 ± 0.11 | ND | ND | <1.00 | <1.00 | <1.00 |
| | 21 | ND | ND | ND | <1.00 | <1.00 | <1.00 |
| | 28 | ND | ND | ND | <1.00 | <1.00 | <1.00 |
| | 60 | ND | ND | ND | <1.00 | <1.00 | <1.00 |
| YEAST | 0 | 3.21 ± 0.06 | 3.30 ± 0.29 | 3.38 ± 0.18 | 3.42 ± 0.22 | 3.53 ± 0.07 | 3.45 ± 0.15 |
| Candida krusei | 7 | 6.84 ± 0.10 | 6.75 ± 0.06 | 6.42 ± 0.23 | 6.72 ± 0.07 | 6.53 ± 0.32 | 6.73 ± 0.07 |
| | 14 | ND | ND | ND | ND | ND | ND |
| | 21 | ND | ND | ND | ND | ND | ND |
| | 28 | ND | ND | ND | ND | ND | ND |
| | 60 | ND | ND | ND | ND | ND | ND |
| YEAST | 0 | 3.14 ± 0.06 | 3.47 ± 0.08 | 3.41 ± 0.08 | 3.32 ± 0.02 | 3.48 ± 0.08 | 3.32 ± 0.16 |
| Pichia | 7 | 6.36 ± 0.12 | <1.00 | <1.00 | <1.00 | <1.00 | <1.00 |
| membranaefaciens | 14 | 7.10 ± 0.06 | 3.26 ± 0.24 | 3.16 ± 0.16 | <1.00 | <1.00 | <1.00 |
| | 21 | ND | 6.39 ± 0.46 | 2.48 ± 0.46 | <1.00 | <1.00 | <1.00 |
| | 28 | ND | ND | 7.06 ± 0.06 | 2.35 ± 0.14 | <1.00 | <1.00 |
| | 60 | ND | ND | ND | 5.94 ± 0.61 | <1.00 | <1.00 |
| MOLD | 0 | 2.06 ± 0.10 | 2.12 ± 0.10 | 2.26 ± 0.05 | 2.22 ± 0.05 | 2.06 ± 0.06 | 2.08 ± 0.09 |
| Byssochlamys fulva | 7 | TNTC | TNTC | <1.00 | <1.00 | <1.00 | <1.00 |
| | 14 | ND | ND | <1.00 | <1.00 | <1.00 | <1.00 |
| | 21 | ND | ND | TNTC | TNTC | <1.00 | <1.00 |
| | 28 | ND | ND | ND | ND | <1.00 | <1.00 |
| | 60 | ND | ND | ND | ND | <1.00 | <1.00 |
| MOLD | 0 | 1.96 ± 0.06 | 2.14 ± 0.06 | 2.11 ± 0.03 | 2.04 ± 0.04 | 2.01 ± 0.02 | 1.90 ± 0.05 |
| Neosartorya fischeri | 7 | TNTC | TNTC | TNTC | TNTC | TNTC | TNTC |
| | 14 | ND | ND | ND | ND | ND | ND |
| MOLD | 0 | 2.10 ± 0.06 | 2.30 ± 0.01 | 2.05 ± 0.04 | 2.11 ± 0.07 | 2.00 ± 0.04 | 2.13 ± 0.02 |
| Fusarium oxysporum | 7 | TNTC | TNTC | TNTC | TNTC | TNTC | TNTC |
| | 14 | ND | ND | ND | ND | ND | ND |
| MOLD | 0 | 1.96 ± 0.08 | 2.06 ± 0.06 | 1.91 ± 0.12 | 1.94 ± 0.03 | 2.02 ± 0.08 | 2.05 ± 0.06 |
| Penicillium italicum | 7 | TNTC | TNTC | <1.00 | <1.00 | <1.00 | <1.00 |
| | 14 | ND | ND | 3.13 ± 0.15 | 3.23 ± 0.21 | 1.16 ± 0.15 | <1.00 |
| | 21 | ND | ND | 2.45 ± 0.50 | <1.00 | <1.00 | <1.00 |
| | 28 | ND | ND | <1.00 | <1.00 | <1.00 | <1.00 |
| | 60 | ND | ND | <1.00 | <1.00 | <1.00 | <1.00 |
| BACTERIA | 0 | 3.23 ± 0.10 | 3.21 ± 0.08 | 3.34 ± 0.08 | 3.40 ± 0.15 | 3.24 ± 0.28 | 3.29 ± 0.13 |
| Gluconacetobacter | 3 | 8.10 ± 0.10 | 6.94 ± 0.67 | 1.40 ± 0.45 | 1.40 ± 0.46 | 2.00 ± 0.09 | 1.52 ± 0.45 |
| xylinus | 6 | ND | ND | 3.37 ± 0.33 | 3.32 ± 0.30 | 2.44 ± 0.45 | 2.32 ± 0.30 |
| | 12 | ND | ND | 7.43 ± 0.16 | 6.92 ± 0.43 | <1.00 | <1.00 |
| | 20 | ND | ND | ND | ND | <1.00 | <1.00 |
| | 60 | ND | ND | ND | ND | <1.00 | <1.00 |
| BACTERIA | 0 | 3.10 ± 0.08 | 3.26 ± 0.08 | 3.27 ± 0.13 | 3.18 ± 0.17 | 3.15 ± 0.21 | 3.24 ± 0.28 |
| Alicyclobacillus | 3 | 8.16 ± 0.12 | 8.22 ± 0.22 | <1.00 | <1.00 | <1.00 | <1.00 |
| acidoterrestris | 6 | ND | ND | <1.00 | <1.00 | <1.00 | <1.00 |
| | 12 | ND | ND | <1.00 | <1.00 | <1.00 | <1.00 |
| | 20 | ND | ND | <1.00 | <1.00 | <1.00 | <1.00 |
| | 60 | ND | ND | <1.00 | <1.00 | <1.00 | <1.00 |
| BACTERIA | 0 | 3.24 ± 0.06 | 3.31 ± 0.09 | 3.20 ± 0.18 | 3.35 ± 0.08 | 3.29 ± 0.14 | 3.29 ± 0.05 |
| Bacillus | 3 | 8.12 ± 0.06 | 7.14 ± 0.32 | <1.00 | <1.00 | <1.00 | <1.00 |
| stearothermophilus | 6 | ND | ND | <1.00 | <1.00 | <1.00 | <1.00 |
| | 12 | ND | ND | 1.65 ± 0.33 | 1.72 ± 0.36 | <1.00 | <1.00 |
| | 20 | ND | ND | 7.32 ± 0.29 | 6.61 ± 0.74 | 4.98 ± 0.75 | 2.97 ± 0.77 |
| | 60 | ND | ND | ND | ND | <1.00 | <1.00 |
| BACTERIA | 0 | 3.10 ± 0.06 | 3.55 ± 0.07 | 3.30 ± 0.27 | 3.23 ± 0.23 | 3.17 ± 0.17 | 3.24 ± 0.14 |
| Clostridium botulinum | 3 | 8.25 ± 0.03 | <1.00 | <1.00 | <1.00 | <1.00 | <1.00 |
| | 6 | ND | <1.00 | <1.00 | <1.00 | <1.00 | <1.00 |
| | 12 | ND | <1.00 | <1.00 | <1.00 | <1.00 | <1.00 |
| | 20 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.21 ± 0.047 | 3.39 ± 0.25 | 3.47 ± 0.35 | 3.22 ± 0.21 | 3.21 ± 0.23 | 3.38 ± 0.20 |
| Clostridium | 3 | 8.12 ± 0.06 | <1.00 | <1.00 | <1.00 | <1.00 | <1.00 |
| acetobutyricum | 6 | ND | <1.00 | <1.00 | <1.00 | <1.00 | <1.00 |
| | 12 | ND | <1.00 | <1.00 | <1.00 | <1.00 | <1.00 |
| | 20 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.21 ± 0.14 | 3.34 ± 0.16 | 3.41 ± 0.17 | 3.51 ± 0.10 | 3.35 ± 0.21 | 3.27 ± 0.14 |
| Leuconostoc oenus | 3 | 7.42 ± 0.09 | 2.44 ± 0.33 | 2.50 ± 0.10 | 1.53 ± 0.21 | <1.00 | <1.00 |
| | 6 | ND | 7.58 ± 0.03 | 8.04 ± 0.43 | 8.04 ± 0.43 | 4.05 ± 0.65 | 3.60 ± 0.63 |
| | 12 | ND | ND | ND | ND | 5.01 ± 0.51 | 5.84 ± 0.69 |
| BACTERIA | 0 | 3.19 ± 0.22 | 3.25 ± 0.02 | 3.31 ± 0.12 | 3.29 ± 0.04 | 3.27 ± 0.16 | 3.21 ± 0.17 |
| Leuconostoc. | 3 | 6.26 ± 0.21 | <1.00 | <1.00 | <1.00 | <1.00 | <1.00 |
| pseudomesenteroides | 6 | ND | <1.00 | <1.00 | <1.00 | <1.00 | <1.00 |
| | 12 | ND | <1.00 | <1.00 | <1.00 | <1.00 | <1.00 |
| | 20 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.32 ± 0.06 | 3.36 ± 0.12 | 3.31 ± 0.13 | 3.27 ± 0.13 | 3.29 ± 0.12 | 3.24 ± 0.18 |
| Lactobacillus | 3 | 7.56 ± 0.11 | <1.00 | <1.00 | <1.00 | <1.00 | <1.00 |
| acetotolerans | 6 | ND | <1.00 | <1.00 | <1.00 | <1.00 | <1.00 |
| | 12 | ND | 7.06 ± 0.40 | 6.23 ± 0.18 | 4.63 ± 0.26 | 5.30 ± 0.26 | 4.43 ± 0.19 |

ND represents “not done”;
TNTC represents “too numerous to count.”

TABLE THREE
Evaluation of higher levels of Yucca extract against different molds and yeasts in malt extract broth at
pH 5.0, 25° C. Levels of microorganisms are shown in mean log₁₀ CFU/ml ± SD.

| | | Yucca extract concentrations (ppm) | | | | |
|---|---|---|---|---|---|---|
| Yeast strain | Time (days) | 0 | 3000 | 5000 | 7000 | 10,000 |
| YEAST | 0 | 3.26 ± 0.10 | 3.33 ± 0.06 | 3.17 ± 0.09 | 3.31 ± 0.02 | 3.08 ± 0.09 |
| Candida krusei | 7 | 6.21 ± 0.06 | <1.00 | <1.00 | <1.00 | <1.00 |
| | 14 | ND | <1.00 | <1.00 | <1.00 | <1.00 |
| | 21 | ND | <1.00 | <1.00 | <1.00 | <1.00 |
| | 28 | ND | <1.00 | <1.00 | <1.00 | <1.00 |
| | 60 | ND | <1.00 | <1.00 | <1.00 | <1.00 |
| MOLD | 0 | 2.16 ± 0.11 | 2.14 ± 0.03 | 2.05 ± 0.06 | 2.01 ± 0.02 | 2.14 ± 0.15 |
| Byssochlamys fulva | 7 | TNTC | <1.00 | <1.00 | <1.00 | <1.00 |
| | 14 | ND | <1.00 | <1.00 | <1.00 | <1.00 |
| | 21 | ND | TNTC | <1.00 | <1.00 | <1.00 |
| | 28 | ND | ND | <1.00 | <1.00 | <1.00 |
| | 60 | ND | ND | <1.00 | <1.00 | <1.00 |
| MOLD | 0 | 2.21 ± 0.12 | 1.97 ± 0.07 | 2.11 ± 0.07 | 2.33 ± 0.03 | 1.86 ± 0.03 |
| Neosartorya fischeri | 7 | TNTC | <1.00 | <1.00 | <1.00 | <1.00 |
| | 14 | ND | TNTC | TNTC | TNTC | TNTC |
| | 21 | ND | ND | ND | ND | ND |
| | 28 | ND | ND | ND | ND | ND |
| | 60 | ND | ND | ND | ND | ND |
| MOLD | 0 | 2.36 ± 0.05 | 2.14 ± 0.09 | 2.06 ± 0.06 | 1.92 ± 0.03 | 2.13 ± 0.16 |
| Fusarium oxysporum | 7 | TNTC | TNTC | TNTC | TNTC | TNTC |
| | 14 | ND | ND | ND | ND | ND |
| | 21 | ND | ND | ND | ND | ND |
| | 28 | ND | ND | ND | ND | ND |
| | 60 | ND | ND | ND | ND | ND |
| MOLD | 0 | 2.00 ± 0.11 | 1.86 ± 0.03 | 1.97 ± 0.03 | 2.11 ± 0.18 | 1.95 ± 0.05 |
| Penicillium italicum | 7 | TNTC | <1.00 | <1.00 | <1.00 | <1.00 |
| | 14 | ND | <1.00 | <1.00 | <1.00 | <1.00 |
| | 21 | ND | <1.00 | <1.00 | <1.00 | <1.00 |
| | 28 | ND | <1.00 | <1.00 | <1.00 | <1.00 |
| | 60 | ND | <1.00 | <1.00 | <1.00 | <1.00 |

ND represents “not done”;
TNTC represents “too numerous to count.”

TABLE FOUR
Evaluation of a mixture of 200 ppm benzoate, 150 ppm
sorbate and 25 ppm EDTA against different microorganisms
at 25° C. in malt extract broth (pH 5.0).
Levels of microorganisms are shown in mean log₁₀ CFU/ml ± SD.

| | | Benzoate/Sorbate/EDTA | |
|---|---|---|---|
| | Time | concentrations (mg/L) | |
| Microorganism | (days) | 0 | 200/150/25 |
| YEAST | 0 | 3.16 ± 0.09 | 3.20 ± 0.12 |
| Zygosaccharomyces | 7 | 7.12 ± 0.09 | 7.13 ± 0.17 |
| bailii | 14 | ND | ND |
| YEAST | 0 | 3.22 ± 0.14 | 3.40 ± 0.08 |
| Dekkera bruxellensis | 7 | 6.75 ± 0.12 | 6.63 ± 0.15 |
| | 14 | ND | ND |
| YEAST | 0 | 3.05 ± 0.14 | 3.18 ± 0.02 |
| Saccharomyces | 7 | 7.12 ± 0.15 | 7.49 ± 0.10 |
| cerevisiae | 14 | ND | ND |
| YEAST | 0 | 3.13 ± 0.17 | 3.26 ± 0.07 |
| Candida krusei | 7 | 6.05 ± 0.09 | 5.95 ± 0.05 |
| | 14 | ND | ND |
| YEAST | 0 | 3.12 ± 0.12 | 3.25 ± 0.10 |
| Pichia | 7 | 7.02 ± 0.21 | 6.96 ± 0.05 |
| membranaefaciens | 14 | ND | ND |
| MOLD | 0 | 2.21 ± 0.12 | 2.14 ± 0.16 |
| Byssochlamys fulva | 7 | TNTC | TNTC |
| | 14 | ND | ND |
| MOLD | 0 | 2.35 ± 0.26 | 2.29 ± 0.19 |
| Neosartorya fischeri | 7 | TNTC | TNTC |
| | 14 | ND | ND |
| MOLD | 0 | 2.13 ± 0.06 | 2.21 ± 0.03 |
| Fusarium oxysporum | 7 | TNTC | TNTC |
| | 14 | ND | ND |
| MOLD | 0 | 2.21 ± 0.13 | 2.30 ± 0.18 |
| Penicillium italicum | 7 | TNTC | TNTC |
| | 14 | ND | ND |
| BACTERIA | 0 | 3.26 ± 0.08 | 3.21 ± 0.23 |
| Gluconacetobacter | 3 | 8.17 ± 0.12 | 2.22 ± 0.23 |
| xylinus | 6 | ND | 4.71 ± 0.65 |
| | 12 | ND | 6.57 ± 0.38 |
| | 20 | ND | ND |
| | 60 | ND | ND |
| BACTERIA | 0 | 3.18 ± 0.22 | 3.21 ± 0.23 |
| Alicyclobacillus | 3 | 8.06 ± 0.02 | <1.00 |
| acidoterrestris | 6 | ND | <1.00 |
| | 12 | ND | <1.00 |
| | 20 | ND | <1.00 |
| | 60 | ND | <1.00 |
| BACTERIA | 0 | 3.48 ± 0.28 | 3.30 ± 0.18 |
| Bacillus | 3 | 8.17 ± 0.12 | <1.00 |
| stearothermophilus | 6 | ND | 2.62 ± 0.72 |
| | 12 | ND | 8.04 ± 0.33 |
| | 20 | ND | ND |
| | 60 | ND | ND |
| BACTERIA | 0 | 3.27 ± 0.15 | 3.34 ± 0.21 |
| Clostridium botulinum | 3 | 8.29 ± 0.36 | <1.00 |
| | 6 | ND | <1.00 |
| | 12 | ND | <1.00 |
| | 20 | ND | <1.00 |
| | 60 | ND | <1.00 |
| BACTERIA | 0 | 3.16 ± 0.28 | 3.44 ± 0.21 |
| Clostridium | 3 | 7.69 ± 0.05 | <1.00 |
| acetobutyricum | 6 | ND | <1.00 |
| | 12 | ND | <1.00 |
| | 20 | ND | <1.00 |
| | 60 | ND | <1.00 |
| BACTERIA | 0 | 3.36 ± 0.19 | 3.20 ± 0.12 |
| Leuconostoc oenus | 3 | 7.85 ± 0.18 | 2.51 ± 0.43 |
| | 6 | ND | 7.49 ± 0.16 |
| BACTERIA | 0 | 3.52 ± 0.06 | 3.34 ± 0.16 |
| L. pseudomesenteroides | 3 | 6.08 ± 0.61 | 1.55 ± 0.59 |
| | 6 | ND | <1.00 |
| | 12 | ND | <1.00 |
| | 20 | ND | <1.00 |
| | 60 | ND | <1.00 |
| BACTERIA | 0 | 3.24 ± 0.19 | 3.26 ± 0.10 |
| Lactobacillus | 3 | 8.12 ± 0.09 | <1.00 |
| acetotolerans | 6 | ND | <1.00 |

ND represents “not done”;
TNTC represents “too numerous to count.”

From Tables TWO and THREE, the at least one saponin-comprising extract leads to observed death of many yeast species by about 3 log CFU/ml and some molds by about 2 log CFU/ml and bacteria by about 3 log CFU/ml in the pH 5.0 broth systems. This supports the antimicrobial potential of the Yucca extract, i.e., at least one saponin-comprising extract in beverages. It also demonstrates that inhibition can be achieved using levels at or lower than 100 ppm, which was the minimum concentration tested. Further, inhibition and even death of microorganisms may be likely to occur when saponin-comprising extracts are used in conjunction with other antimicrobial compounds. The data in Tables TWO and THREE compared with Table FOUR suggests that the at least one saponin-comprising extract may provide enhanced microbial inhibition in comparison to traditional beverage preservatives such as the combination of benzoate, sorbate and EDTA.

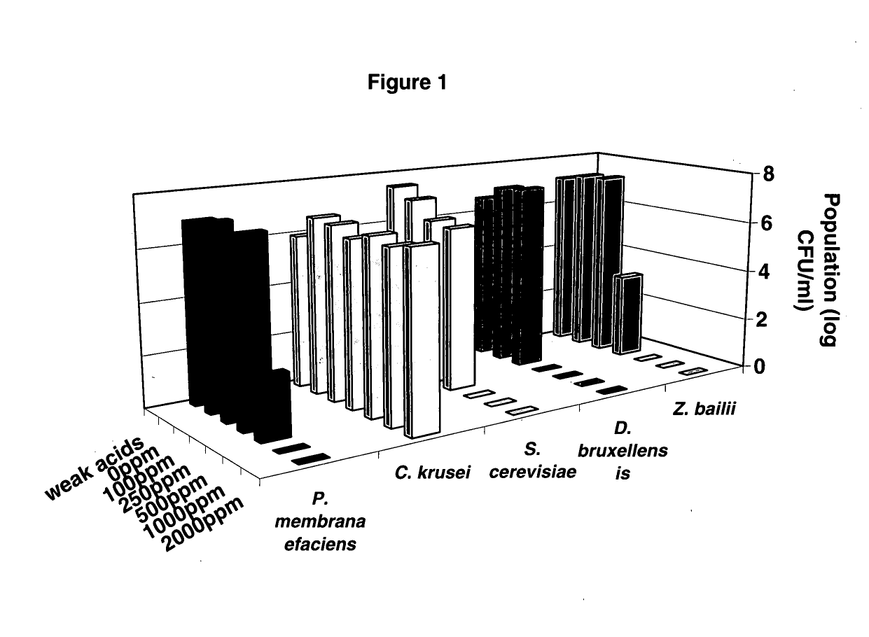

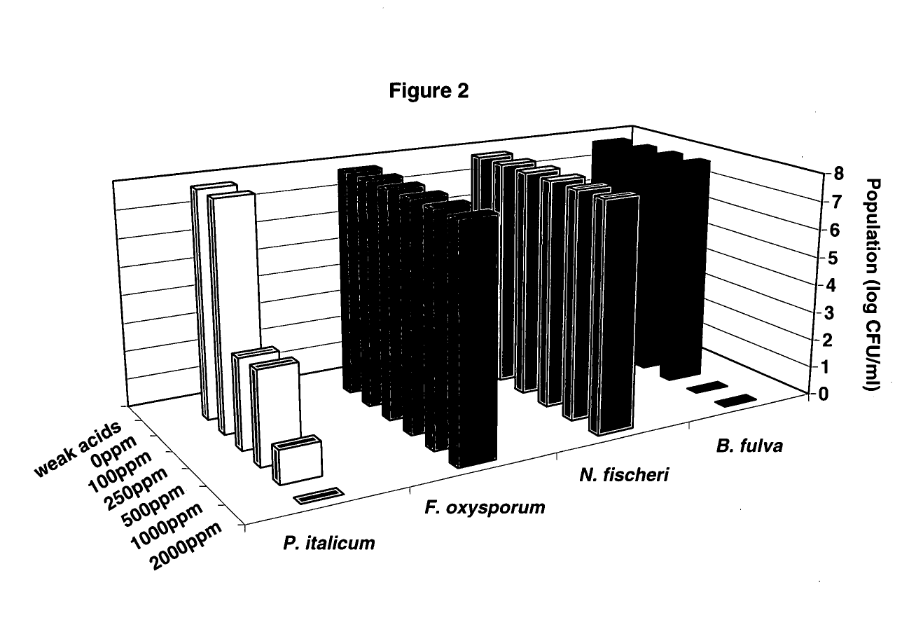

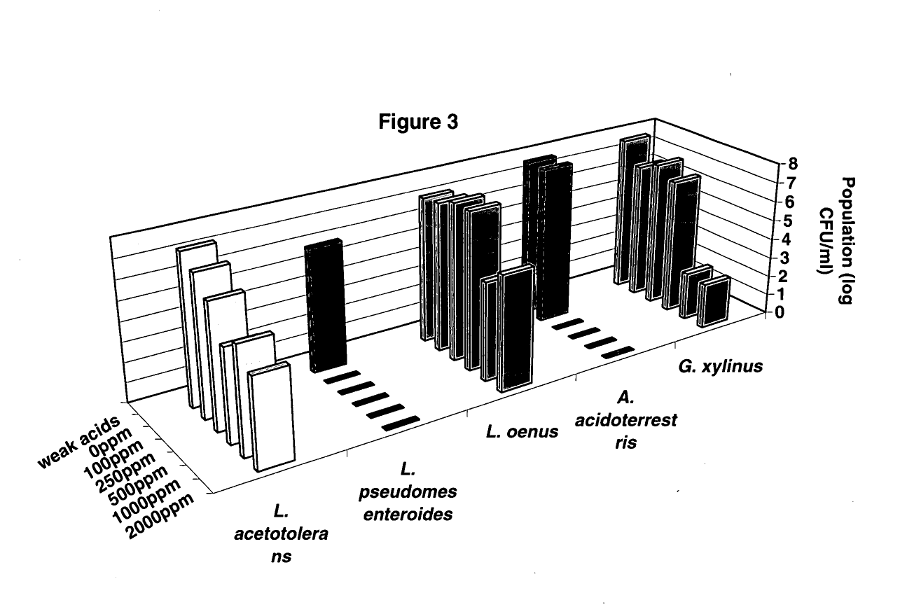

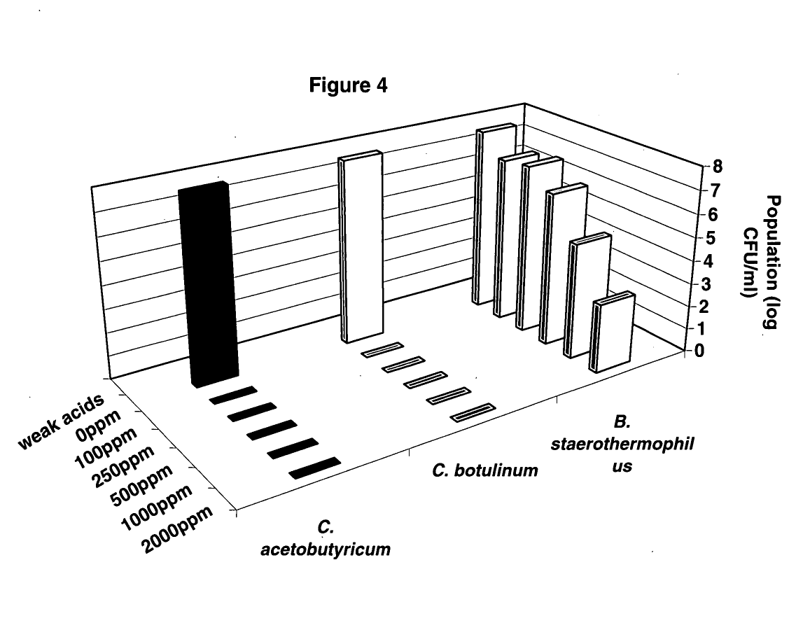

From the data in Tables TWO and FOUR, FIGS. 1 through 4 show the maximum populations of yeasts (FIG. 1), molds (FIG. 2), acidophilic bacteria (FIG. 3), and sporeforming bacteria (FIG. 4) reached within the span of time from day 0 to day 28 in weak acid preserved and Yucca-extract preserved malt extract broth.

In the next experiments, the inventors replaced the malt extract broth with a model beverage system, i.e., a sucrose solution acidified to pH 3.0 with citric acid. This type of sucrose media is commonly used in the industry, and allows for systemic testing of microorganisms in a growth environment representative of most acidic, shelf-stable, ready-to-drink beverages. In addition, sucrose or a similarly functioning sweetener is often found in a beverage and citric acid is a commonly used acidulant in a beverage, i.e., the sucrose and citric acid solution represents an abbreviate beverage matrix. As such, with thriving microorganisms in a growth media, the sucrose solution represents a worse case scenario in comparison to a traditional carbonated beverage consisting of sweetener, acid, and carbonated water because the sucrose solution provides ample fermentable carbohydrate for microorganisms and lack of carbonation (i.e. greater presence of oxygen) will give greater growth potential for molds and bacteria.

The data presented below in Tables FIVE through TEN utilized stock solutions of 20 ml/L and 10 ml/L of Yucca or Quillaja extract prepared by aseptically adding 20 ml or 10 ml of Yucca or Quillaja extract to 980 ml to 990 ml of a sucrose solution comprising distilled water, high fructose corn syrup or sucrose, and granular acid to adjust the pH to about 3.0 to about 3.1. Antimicrobial assays for each saponin-comprising extract were separately set up using working solutions prepared at final Yucca and Quillaja concentrations of 0.1, 0.25, 00.5,1 and 2 ml/L, as follows: for a 0.1 ml/L (100 ppm) solution, 0.1 ml from the 10 ml/L stock into 9.9 ml of the sucrose solution; for 0.25 ml/L (250 ppm) solution, 0.25 ml of the 10 ml stock in 9.75 ml of the sucrose solution; for the 0.5 ml/L (500 ppm)solution, 0.25 ml of the 20 ml/L stock in 9.75 ml of the sucrose solution; for the 1 ml/L (1000 ppm) solution, 0.5 ml of the 20 ml/L stock into 9.5 ml of the sucrose solution; and for the 2 ml/L (2000 ppm) solution, 1 ml of the 20 ml stock in 9.0 ml of the sucrose solution. As mentioned, those dilutions were based on volume/volume percentages and as such, the ppm values listed above should be multiplied by the density of the undiluted crude extract of Yucca, i.e., 1.22 g/ml, in order to obtain a more accurate ppm value. Thus, for the 100 ppm solution, the ppm value was 122 ppm. Likewise, the 250 ppm solution should be 305 ppm, the 500 ppm solution should be 610 ppm, the 1000 ppm solution should be 1220 ppm, and the 2000 ppm solution should be 2440 ppm.

The pH of the undiluted Yucca extract was around 3.8 and that of the undiluted Quillaja extract was around 3.9. The stock solutions prepared in the sucrose system had a pH of around 3.0 to 3.14 and thus, the addition of the stock solution to the sucrose solution resulted in a minimal change in pH, if any.

TABLE FIVE
Evaluation of Yucca extract against different molds, yeasts, and bacteria in sucrose solutions at pH
3.0, 25° C. Level of microorganisms are shown in mean log₁₀ CFU/ml ± SD.

| | |
|---|---|
| Time | Yucca extract concentrations (ppm) |

| Microorganism | (days) | 0 | 100 | 250 | 500 | 1000 | 2000 |
|---|---|---|---|---|---|---|---|
| YEAST | 0 | 3.36 ± 0.19 | 3.35 ± 0.14 | 3.41 ± 0.08 | 3.50 ± 0.02 | 3.50 ± 0.03 | 3.55 ± 0.05 |
| Zygosaccharomyces | 7 | 5.29 ± 0.15 | <1.00 | <1.00 | <1.00 | <1.00 | <1.00 |
| bailii | 14 | 7.96 ± 0.26 | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.44 ± 0.11 | 3.43 ± 0.06 | 3.44 ± 0.04 | 3.49 ± 0.08 | 3.44 ± 0.09 | 3.48 ± 0.12 |
| Dekkera bruxellensis | 7 | 4.28 ± 0.15 | <1.00 | <1.00 | <1.00 | <1.00 | <1.00 |
| | 14 | 7.00 ± 0.12 | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.35 ± 0.18 | 3.34 ± 0.09 | 3.31 ± 0.14 | 3.31 ± 0.15 | 3.29 ± 0.15 | 3.21 ± 0.17 |
| Saccharomyces | 7 | 7.24 ± 0.43 | <1.00 | <1.00 | <1.00 | <1.00 | <1.00 |
| cerevisiae | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.41 ± 0.08 | 3.36 ± 0.07 | 3.31 ± 0.07 | 3.27 ± 0.06 | 3.38 ± 0.21 | 3.33 ± 0.17 |
| Candida krusei | 7 | 7.66 ± 0.20 | <1.00 | <1.00 | <1.00 | <1.00 | <1.00 |
| | 14 | ND | 2.57 ± 0.21 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.44 ± 0.06 | 3.41 ± 0.18 | 3.34 ± 0.08 | 3.33 ± 0.07 | 3.33 ± 0.14 | 3.28 ± 0.19 |
| Pichia | 7 | 4.28 ± 0.13 | <1.00 | <1.00 | <1.00 | <1.00 | <1.00 |
| membranaefaciens | 14 | 6.32 ± 0.10 | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| MOLD | 0 | 2.33 ± 0.19 | 2.34 ± 0.12 | 2.36 ± 0.16 | 2.36 ± 0.25 | 2.26 ± 0.22 | 2.33 ± 0.14 |
| Byssochlamys fulva | 7 | TNTC | 2.71 ± 0.60 | 2.82 ± 0.17 | 2.21 ± 0.20 | 0.57 ± 0.88 | 0.43 ± 0.75 |
| | 14 | ND | TNTC | TNTC | TNTC | <1.00 | <1.00 |
| | 21 | ND | ND | ND | ND | <1.00 | <1.00 |
| | 28 | ND | ND | ND | ND | <1.00 | <1.00 |
| | 60 | ND | ND | ND | ND | <1.00 | <1.00 |
| MOLD | 0 | 2.39 ± 0.29 | 2.36 ± 0.11 | 2.43 ± 0.14 | 2.39 ± 0.19 | 2.47 ± 0.12 | 2.51 ± 0.10 |
| Neosartorya fischeri | 7 | TNTC | TNTC | TNTC | TNTC | TNTC | TNTC |
| | 14 | ND | ND | ND | ND | ND | ND |
| | 21 | ND | ND | ND | ND | ND | ND |
| | 28 | ND | ND | ND | ND | ND | ND |
| | 60 | ND | ND | ND | ND | ND | ND |
| MOLD | 0 | 2.29 ± 0.09 | 2.23 ± 0.07 | 2.25 ± 0.16 | 2.25 ± 0.05 | 2.28 ± 0.10 | 2.24 ± 0.21 |
| Fusarium oxysporum | 7 | TNTC | TNTC | TNTC | TNTC | TNTC | 2.86 ± 0.17 |
| | 14 | ND | ND | ND | ND | ND | TNTC |
| | 21 | ND | ND | ND | ND | ND | ND |
| | 28 | ND | ND | ND | ND | ND | ND |
| | 60 | ND | ND | ND | ND | ND | ND |
| MOLD | 0 | 2.33 ± 0.19 | 2.31 ± 0.10 | 2.25 ± 0.12 | 2.21 ± 0.19 | 2.22 ± 0.12 | 2.22 ± 0.09 |
| Penicillium italicum | 7 | TNTC | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | TNTC | TNTC | TNTC | TNTC | TNTC |
| | 60 | ND | TNTC | TNTC | TNTC | TNTC | TNTC |
| BACTERIA | 0 | 3.39 ± 0.22 | 3.31 ± 0.14 | 3.36 ± 0.16 | 3.43 ± 0.06 | 3.34 ± 0.15 | 3.38 ± 0.18 |
| Gluconacetobacter | 7 | 5.12 ± 0.26 | <1.00 | <1.00 | <1.00 | <1.00 | <1.00 |
| xylinus | 14 | 7.69 ± 0.22 | <1.00 | <1.00 | <1.00 | <1.00 | <1.00 |
| | 21 | ND | <1.00 | <1.00 | <1.00 | <1.00 | <1.00 |
| | 28 | ND | 7.13 ± 0.65 | <1.00 | <1.00 | <1.00 | <1.00 |
| | 60 | ND | ND | <1.00 | <1.00 | <1.00 | <1.00 |
| BACTERIA | 0 | 3.25 ± 0.14 | 3.26 ± 0.17 | 3.31 ± 0.06 | 3.33 ± 0.14 | 3.25 ± 0.13 | 3.17 ± 0.26 |
| Alicyclobacillus | 7 | 3.38 ± 0.65 | <1.00 | <1.00 | <1.00 | <1.00 | <1.00 |
| acidoterrestris | 14 | 3.74 ± 0.42 | <1.00 | <1.00 | <1.00 | <1.00 | <1.00 |
| | 21 | 4.28 ± 0.36 | <1.00 | <1.00 | <1.00 | <1.00 | <1.00 |
| | 28 | 4.16 ± 0.12 | <1.00 | <1.00 | <1.00 | <1.00 | <1.00 |
| | 60 | <1.00 | <1.00 | <1.00 | <1.00 | <1.00 | <1.00 |
| BACTERIA | 0 | 3.40 ± 0.15 | 3.36 ± 0.16 | 3.29 ± 0.13 | 3.34 ± 0.14 | 3.29 ± 0.15 | 3.30 ± 0.12 |
| Bacillus | 7 | 3.52 ± 0.38 | <1.00 | <1.00 | <1.00 | <1.00 | <1.00 |
| stearothermophilus | 14 | 3.76 ± 0.28 | <1.00 | <1.00 | <1.00 | <1.00 | <1.00 |
| | 21 | 3.69 ± 0.44 | <1.00 | <1.00 | <1.00 | <1.00 | <1.00 |
| | 28 | 4.01 ± 0.10 | <1.00 | <1.00 | <1.00 | <1.00 | <1.00 |
| | 60 | 4.09 ± 0.28 | <1.00 | <1.00 | <1.00 | <1.00 | <1.00 |
| BACTERIA | 0 | 3.29 ± 0.11 | 3.21 ± 0.23 | 3.41 ± 0.03 | 3.35 ± 0.11 | 3.33 ± 0.13 | 3.30 ± 0.12 |
| Clostridium botulinum | 7 | 7.15 ± 0.22 | <1.00 | <1.00 | <1.00 | <1.00 | <1.00 |
| | 14 | ND | 6.84 ± 0.60 | <1.00 | <1.00 | <1.00 | <1.00 |
| | 21 | ND | ND | <1.00 | <1.00 | <1.00 | <1.00 |
| | 28 | ND | ND | <1.00 | <1.00 | <1.00 | <1.00 |
| | 60 | ND | ND | <1.00 | <1.00 | <1.00 | <1.00 |
| BACTERIA | 0 | 3.28 ± 0.10 | 3.22 ± 0.17 | 3.38 ± 0.11 | 3.31 ± 0.14 | 3.30 ± 0.12 | 3.31 ± 0.14 |
| Clostridium | 7 | 6.85 ± 0.18 | <1.00 | <1.00 | <1.00 | <1.00 | <1.00 |
| acetobutyricum | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.25 ± 0.18 | 3.35 ± 0.07 | 3.33 ± 0.11 | 3.28 ± 0.06 | 3.29 ± 0.11 | 3.24 ± 0.22 |
| Leuconostoc oenus | 7 | <1.00 | <1.00 | <1.00 | <1.00 | <1.00 | <1.00 |
| | 14 | <1.00 | <1.00 | <1.00 | <1.00 | <1.00 | <1.00 |
| | 21 | <1.00 | <1.00 | <1.00 | <1.00 | <1.00 | <1.00 |
| | 28 | <1.00 | <1.00 | <1.00 | <1.00 | <1.00 | <1.00 |
| | 60 | <1.00 | <1.00 | <1.00 | <1.00 | <1.00 | <1.00 |
| BACTERIA | 0 | 3.20 ± 0.06 | 3.35 ± 0.11 | 3.37 ± 0.09 | 3.28 ± 0.10 | 3.19 ± 0.21 | 3.21 ± 0.22 |
| L. pseudomesenteroides | 7 | 6.00 ± 0.13 | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.11 ± 0.40 | | | | | |
| Lactobacillus | 7 | 6.54 ± 0.10 | <1.00 | <1.00 | <1.00 | <1.00 | <1.00 |
| acetotolerans | 14 | ND | <1.00 | <1.00 | <1.00 | <1.00 | <1.00 |
| | 21 | ND | <1.00 | <1.00 | <1.00 | <1.00 | <1.00 |
| | 28 | ND | 2.20 ± 0.45 | <1.00 | <1.00 | <1.00 | <1.00 |
| | 60 | ND | <1.00 | <1.00 | <1.00 | <1.00 | <1.00 |

ND represents “not done”;
TNTC represents “too numerous to count.”

TABLE SIX
Evaluation of Yucca extract against different bacteria in sucrose solutions at pH 3.0 at the optimum
temperature of each organism (25°–37° C. for mesophiles and 42°–55° C. for
thermophiles). Level of microorganisms are shown in mean log₁₀ CFU/ml ± SD.

| | Time | Yucca extract concentration (ppm) | | | | | |
|---|---|---|---|---|---|---|---|
| Bacterial strain | (days) | 0 | 100 | 250 | 500 | 1000 | 2000 |
| BACTERIA | 0 | 3.34 ± 0.18 | 3.27 ± 0.16 | 3.32 ± 0.06 | 3.40 ± 0.04 | 3.37 ± 0.09 | 3.46 ± 0.04 |
| Gluconacetobacter | 7 | 8.19 ± 0.24 | 3.31 ± 0.32 | 2.65 ± 0.45 | 1.98 ± 0.40 | 1.58 ± 0.51 | 1.78 ± 0.43 |
| xylinus | 14 | ND | 3.08 ± 0.39 | 2.62 ± 0.08 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.34 ± 0.21 | 3.38 ± 0.15 | 3.18 ± 0.22 | 3.38 ± 0.18 | 3.35 ± 0.23 | 3.22 ± 0.15 |
| Alicyclobacillus | 7 | 3.45 ± 0.20 | <1.00 | <1.00 | <1.00 | <1.00 | <1.00 |
| acidoterrestris | 14 | 3.28 ± 0.39 | <1.00 | <1.00 | <1.00 | <1.00 | <1.00 |
| | 21 | 3.41 ± 0.26 | <1.00 | <1.00 | <1.00 | <1.00 | <1.00 |
| | 28 | 3.46 ± 0.31 | <1.00 | <1.00 | <1.00 | <1.00 | <1.00 |
| | 60 | 3.62 ± 0.40 | <1.00 | <1.00 | <1.00 | <1.00 | <1.00 |
| BACTERIA | 0 | 3.31 ± 0.08 | 3.29 ± 0.25 | 3.25 ± 0.22 | 3.37 ± 0.11 | 3.37 ± 0.06 | 3.28 ± 0.06 |
| Bacillus | 7 | 3.43 ± 0.37 | <1.00 | <1.00 | <1.00 | <1.00 | <1.00 |
| stearothermophilus | 14 | 3.69 ± 0.38 | <1.00 | <1.00 | <1.00 | <1.00 | <1.00 |
| | 21 | 4.15 ± 0.57 | <1.00 | <1.00 | <1.00 | <1.00 | <1.00 |
| | 28 | 4.11 ± 0.53 | <1.00 | <1.00 | <1.00 | <1.00 | <1.00 |
| | 60 | 4.36 ± 0.50 | <1.00 | <1.00 | <1.00 | <1.00 | <1.00 |
| BACTERIA | 0 | 3.34 ± 0.18 | 3.27 ± 0.08 | 3.31 ± 0.21 | 3.35 ± 0.17 | 3.34 ± 0.08 | 3.32 ± 0.15 |
| Clostridium botulinum | 7 | 8.34 ± 0.21 | 8.35 ± 0.06 | 6.34 ± 0.09 | 6.34 ± 0.10 | 5.45 ± 0.10 | 1.20 ± 1.04 |
| | 14 | ND | ND | ND | ND | ND | 2.48 ± 0.32 |
| | 21 | ND | ND | ND | ND | ND | 2.43 ± 0.360 |
| | 28 | ND | ND | ND | ND | ND | <1.00 |
| | 60 | ND | ND | ND | ND | ND | <1.00 |
| BACTERIA | 0 | 3.31 ± 0.18 | 3.33 ± 0.09 | 3.34 ± 0.07 | 3.32 ± 0.08 | 3.36 ± 0.09 | 3.29 ± 0.11 |
| Clostridium | 7 | 8.14 ± 0.12 | <1.00 | <1.00 | <1.00 | <1.00 | <1.00 |
| acetobutyricum | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.34 ± 0.25 | 3.44 ± 0.03 | 3.30 ± 0.15 | 3.38 ± 0.07 | 3.31 ± 0.14 | 3.39 ± 0.12 |
| Leuconostoc oenus | 7 | <1.00 | <1.00 | <1.00 | <1.00 | <1.00 | <1.00 |
| | 14 | <1.00 | <1.00 | <1.00 | <1.00 | <1.00 | <1.00 |
| | 21 | <1.00 | <1.00 | <1.00 | <1.00 | <1.00 | <1.00 |
| | 28 | <1.00 | <1.00 | <1.00 | <1.00 | <1.00 | <1.00 |
| | 60 | <1.00 | <1.00 | <1.00 | <1.00 | <1.00 | <1.00 |
| BACTERIA | 0 | 3.36 ± 0.15 | 3.38 ± 0.14 | 3.36 ± 0.12 | 3.28 ± 0.24 | 3.33 ± 0.12 | 3.29 ± 0.09 |
| L. pseudomesenteroides | 7 | 5.66 ± 0.20 | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.32 ± 0.14 | 3.36 ± 0.15 | 3.16 ± 0.15 | 3.31 ± 0.06 | 3.25 ± 0.20 | 3.31 ± 0.11 |
| Lactobacillus | 7 | 5.26 ± 0.19 | <1.00 | <1.00 | <1.00 | <1.00 | <1.00 |
| acetotolerans | 14 | ND | 5.36 ± 0.15 | 6.13 ± 0.85 | 5.98 ± 0.44 | 5.28 ± 0.40 | <1.00 |
| | 21 | ND | ND | ND | ND | ND | <1.00 |
| | 28 | ND | ND | ND | ND | ND | <1.00 |
| | 60 | ND | ND | ND | ND | ND | <1.00 |

ND represents “not done”;
TNTC represents “too numerous to count.”

TABLE SEVEN
Evaluation of Quillaja extract against different molds, yeasts, and bacteria in sucrose solutions at
pH 3.0, 25° C. Levels of microorganisms are shown in mean log₁₀ CFU/ml ± SD.

| | Time | Quillaja extract concentrations (ppm) | | | | | |
|---|---|---|---|---|---|---|---|
| Microorganism | (days) | 0 | 100 | 250 | 500 | 1000 | 2000 |
| YEAST | 0 | 3.37 ± 0.21 | 3.39 ± 0.10 | 3.33 ± 0.09 | 3.34 ± 0.17 | 3.34 ± 0.16 | 3.29 ± 0.23 |
| Zygosaccharomyces | 7 | 4.21 ± 0.12 | <1.00 | <1.00 | <1.00 | <1.00 | <1.00 |
| bailii | 14 | 7.98 ± 0.22 | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.34 ± 0.21 | 3.28 ± 0.17 | 3.33 ± 0.13 | 3.32 ± 0.03 | 3.42 ± 0.06 | 3.49 ± 0.10 |
| Dekkera bruxellensis | 7 | 4.12 ± 0.21 | <1.00 | <1.00 | <1.00 | <1.00 | <1.00 |
| | 14 | 5.00 ± 0.21 | <1.00 | <1.00 | <1.00 | <1.00 | <1.00 |
| | 21 | 7.31 ± 0.09 | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.39 ± 0.09 | 3.32 ± 0.04 | 3.32 ± 0.12 | 3.32 ± 0.08 | 3.37 ± 0.18 | 3.32 ± 0.04 |
| Saccharomyces | 7 | 7.45 ± 0.21 | <1.00 | <1.00 | <1.00 | <1.00 | <1.00 |
| cerevisiae | 14 | ND | 2.22 ± 0.23 | 2.17 ± 0.17 | <1.00 | <1.00 | <1.00 |
| | 21 | ND | 2.58 ± 0.32 | 2.43 ± 0.13 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.14 ± 0.12 | 3.20 ± 0.09 | 3.24 ± 0.11 | 3.29 ± 0.09 | 3.25 ± 0.09 | 3.34 ± 0.12 |
| Candida krusei | 7 | 7.49 ± 0.16 | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| YEAST | 0 | 3.32 ± 0.07 | 3.29 ± 0.09 | 3.28 ± 0.08 | 3.27 ± 0.11 | 3.26 ± 0.05 | 3.27 ± 0.09 |
| Pichia | 7 | 3.20 ± 0.09 | <1.00 | <1.00 | <1.00 | <1.00 | <1.00 |
| membranaefaciens | 14 | 6.32 ± 0.09 | <1.00 | <1.00 | <1.00 | <1.00 | <1.00 |
| | 21 | ND | <1.00 | <1.00 | <1.00 | <1.00 | <1.00 |
| | 28 | ND | 7.36 ± 0.19 | 6.44 ± 0.15 | 6.62 ± 0.13 | 5.64 ± 0.21 | 5.40 ± 0.12 |
| | 60 | ND | ND | ND | ND | ND | ND |
| MOLD | 0 | 2.30 ± 0.17 | 2.27 ± 0.16 | 2.26 ± 0.24 | 2.32 ± 0.17 | 2.32 ± 0.15 | 2.39 ± 0.17 |
| Byssochlamys fulva | 7 | TNTC | TNTC | 2.87 ± 0.36 | 2.53 ± 0.08 | 2.64 ± 0.47 | <1.00 |
| | 14 | ND | ND | 2.56 ± 0.09 | 2.30 ± 0.26 | 1.26 ± 0.24 | <1.00 |
| | 21 | ND | ND | 1.65 ± 0.15 | 1.82 ± 0.07 | 1.78 ± 0.26 | <1.00 |
| | 28 | ND | ND | TNTC | TNTC | TNTC | TNTC |
| | 60 | ND | ND | ND | ND | ND | ND |
| MOLD | 0 | 2.23 ± 0.06 | 2.39 ± 0.09 | 2.48 ± 0.03 | 2.46 ± 0.05 | 2.49 ± 0.10 | 2.49 ± 0.06 |
| Neosartorya fischeri | 7 | TNTC | TNTC | TNTC | TNTC | TNTC | TNTC |
| | 14 | ND | ND | ND | ND | ND | ND |
| | 21 | ND | ND | ND | ND | ND | ND |
| | 28 | ND | ND | ND | ND | ND | ND |
| | 60 | ND | ND | ND | ND | ND | ND |
| MOLD | 0 | | 2.37 ± 0.14 | 2.29 ± 0.21 | 2.23 ± 0.21 | 2.23 ± 0.13 | 2.19 ± 0.21 |
| Fusarium oxysporum | 7 | TNTC | TNTC | TNTC | TNTC | TNTC | 2.83 ± 0.13 |
| | 14 | ND | ND | ND | ND | ND | TNTC |
| | 21 | ND | ND | ND | ND | ND | ND |
| | 28 | ND | ND | ND | ND | ND | ND |
| | 60 | ND | ND | ND | ND | ND | ND |
| MOLD | 0 | 2.12 ± 0.08 | 2.17 ± 0.12 | 2.21 ± 0.19 | 2.25 ± 0.13 | 2.23 ± 0.13 | 2.13 ± 0.14 |
| Penicillium italicum | 7 | TNTC | TNTC | TNTC | TNTC | TNTC | TNTC |
| | 14 | ND | ND | ND | ND | ND | ND |
| | 21 | ND | ND | ND | ND | ND | ND |
| | 28 | ND | ND | ND | ND | ND | ND |
| | 60 | ND | ND | ND | ND | ND | ND |
| BACTERIA | 0 | 3.29 ± 0.08 | 3.41 ± 0.03 | 3.39 ± 0.07 | 3.45 ± 0.02 | 3.41 ± 0.03 | 3.32 ± 0.13 |
| Gluconacetobacter | 7 | 3.59 ± 0.09 | <1.00 | <1.00 | <1.00 | <1.00 | <1.00 |
| xylinus | 14 | 7.25 ± 0.36 | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.35 ± 0.11 | 3.32 ± 0.06 | 3.30 ± 0.12 | 3.26 ± 0.10 | 3.27 ± 0.13 | 3.22 ± 0.21 |
| Alicyclobacillus | 7 | 3.49 ± 0.22 | <1.00 | <1.00 | <1.00 | <1.00 | <1.00 |
| acidoterrestris | 14 | 3.59 ± 0.23 | <1.00 | <1.00 | <1.00 | <1.00 | <1.00 |
| | 21 | 3.71 ± 0.32 | <1.00 | <1.00 | <1.00 | <1.00 | <1.00 |
| | 28 | 3.86 ± 0.39 | <1.00 | <1.00 | <1.00 | <1.00 | <1.00 |
| | 60 | 3.93 ± 0.20 | <1.00 | <1.00 | <1.00 | <1.00 | <1.00 |
| BACTERIA | 0 | 3.48 ± 0.12 | 3.50 ± 0.04 | 3.50 ± 0.07 | 3.49 ± 0.02 | 3.52 ± 0.06 | 3.49 ± 0.03 |
| Bacillus | 7 | 3.68 ± 0.32 | <1.00 | <1.00 | <1.00 | <1.00 | <1.00 |
| stearothermophilus | 14 | 3.88 ± 0.47 | <1.00 | <1.00 | <1.00 | <1.00 | <1.00 |
| | 21 | 4.25 ± 0.36 | <1.00 | <1.00 | <1.00 | <1.00 | <1.00 |
| | 28 | 4.32 ± 0.39 | <1.00 | <1.00 | <1.00 | <1.00 | <1.00 |
| | 60 | 4.39 ± 0.41 | <1.00 | <1.00 | <1.00 | <1.00 | <1.00 |
| BACTERIA | 0 | 3.36 ± 0.05 | 3.36 ± 0.16 | 3.38 ± 0.11 | 3.44 ± 0.05 | 3.41 ± 0.05 | 3.41 ± 0.08 |
| Clostridium botulinum | 7 | 8.14 ± 0.14 | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.35 ± 0.25 | 3.37 ± 0.19 | 3.30 ± 0.11 | 3.31 ± 0.14 | 3.31 ± 0.12 | 3.43 ± 0.15 |
| Clostridium | 7 | 8.10 ± 0.16 | <1.00 | <1.00 | <1.00 | <1.00 | <1.00 |
| acetobutyricum | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.39 ± 0.05 | 3.38 ± 0.15 | 3.33 ± 0.11 | 3.44 ± 0.05 | 3.44 ± 0.03 | 3.38 ± 0.08 |
| Leuconostoc oenus | 7 | <1.00 | <1.00 | <1.00 | <1.00 | <1.00 | <1.00 |
| | 14 | <1.00 | <1.00 | <1.00 | <1.00 | <1.00 | <1.00 |
| | 21 | <1.00 | <1.00 | <1.00 | <1.00 | <1.00 | <1.00 |
| | 28 | <1.00 | <1.00 | <1.00 | <1.00 | <1.00 | <1.00 |
| | 60 | <1.00 | <1.00 | <1.00 | <1.00 | <1.00 | <1.00 |
| BACTERIA | 0 | 3.25 ± 0.20 | 3.23 ± 0.12 | 3.26 ± 0.09 | 3.32 ± 0.14 | 3.32 ± 0.13 | 3.28 ± 0.25 |
| L. pseudomesenteroides | 7 | 6.55 ± 0.22 | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.36 ± 0.11 | 3.33 ± 0.17 | 3.36 ± 0.15 | 3.42 ± 0.04 | 3.39 ± 0.08 | 3.38 ± 0.18 |
| Lactobacillus | 7 | 6.05 ± 0.14 | <1.00 | <1.00 | <1.00 | <1.00 | <1.00 |
| acetotolerans | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |

ND represents “not done”;
TNTC represents “too numerous to count.”

TABLE EIGHT
Evaluation of Quillaja extract against different bacteria in sucrose solutions at pH 3.0 at the
optimum temperature of each organism (25°–37° C. for mesophiles and
42°–55° C. for thermophiles). Levels of microorganisms are shown in mean
log₁₀ CFU/ml ± SD.

| | Time | Quillaja concentration (ml/L) | | | | | |
|---|---|---|---|---|---|---|---|
| Bacterial strain | (days) | 0 | 0.1 | 0.25 | 0.5 | 1 | 2 |
| BACTERIA | 0 | 3.36 ± 0.20 | 3.34 ± 0.12 | 3.46 ± 0.03 | 3.45 ± 0.06 | 3.42 ± 0.09 | 3.39 ± 0.19 |
| Gluconacetobacter | 7 | 8.17 ± 0.16 | 8.19 ± 0.22 | 3.06 ± 0.28 | 2.92 ± 0.17 | 2.03 ± 0.37 | 2.37 ± 0.13 |
| xylinus | 14 | ND | ND | 8.25 ± 0.21 | 7.66 ± 0.06 | 7.43 ± 0.25 | 6.41 ± 0.34 |
| | 21 | ND | ND | ND | ND | ND | ND |
| | 28 | ND | ND | ND | ND | ND | ND |
| | 60 | ND | ND | ND | ND | ND | ND |
| BACTERIA | 0 | 3.25 ± 0.14 | 3.27 ± 0.14 | 3.32 ± 0.11 | 3.29 ± 0.13 | 3.19 ± 0.19 | 3.29 ± 0.13 |
| Alicyclobacillus | 7 | 3.20 ± 0.28 | <1.00 | <1.00 | <1.00 | <1.00 | <1.00 |
| acidoterrestris | 14 | 3.30 ± 0.18 | <1.00 | <1.00 | <1.00 | <1.00 | <1.00 |
| | 21 | 3.42 ± 0.37 | <1.00 | <1.00 | <1.00 | <1.00 | <1.00 |
| | 28 | 3.49 ± 0.35 | <1.00 | <1.00 | <1.00 | <1.00 | <1.00 |
| | 60 | 3.52 ± 0.49 | <1.00 | <1.00 | <1.00 | <1.00 | <1.00 |
| BACTERIA | 0 | 3.36 ± 0.17 | 3.37 ± 0.17 | 3.28 ± 0.16 | 3.36 ± 0.14 | 3.32 ± 0.12 | 3.46 ± 0.02 |
| Bacillus | 7 | 3.52 ± 0.38 | <1.00 | <1.00 | <1.00 | <1.00 | <1.00 |
| stearothermophilus | 14 | 3.67 ± 0.21 | <1.00 | <1.00 | <1.00 | <1.00 | <1.00 |
| | 21 | 3.88 ± 0.39 | <1.00 | <1.00 | <1.00 | <1.00 | <1.00 |
| | 28 | 4.16 ± 0.36 | <1.00 | <1.00 | <1.00 | <1.00 | <1.00 |
| | 60 | 4.29 ± 0.42 | <1.00 | <1.00 | <1.00 | <1.00 | <1.00 |
| BACTERIA | 0 | 3.34 ± 0.18 | 3.35 ± 0.08 | 3.43 ± 0.04 | 3.36 ± 0.06 | 3.39 ± 0.09 | 3.39 ± 0.10 |
| Clostridium botulinum | 7 | 8.19 ± 0.14 | 5.79 ± 0.35 | 4.77 ± 0.10 | 3.56 ± 0.13 | 3.19 ± 0.21 | 2.38 ± 0.22 |
| | 14 | ND | ND | 2.37 ± 0.33 | 2.40 ± 0.17 | 2.70 ± 0.37 | 1.59 ± 0.11 |
| | 21 | ND | ND | 3.47 ± 0.17 | 3.47 ± 0.17 | 3.12 ± 0.30 | <1.00 |
| | 28 | ND | ND | 4.43 ± 0.02 | 4.43 ± 0.16 | 3.54 ± 0.14 | <1.00 |
| | 60 | ND | ND | 7.27 ± 0.44 | 7.28 ± 0.72 | 6.71 ± 0.09 | <1.00 |
| BACTERIA | 0 | 3.35 ± 0.14 | 3.33 ± 0.09 | 3.21 ± 0.21 | 3.30 ± 0.13 | 3.29 ± 0.03 | 3.31 ± 0.06 |
| Leuconostoc oenus | 7 | <1.00 | <1.00 | <1.00 | <1.00 | <1.00 | <1.00 |
| | 14 | <1.00 | <1.00 | <1.00 | <1.00 | <1.00 | <1.00 |
| | 21 | <1.00 | <1.00 | <1.00 | <1.00 | <1.00 | <1.00 |
| | 28 | <1.00 | <1.00 | <1.00 | <1.00 | <1.00 | <1.00 |
| | 60 | <1.00 | <1.00 | <1.00 | <1.00 | <1.00 | <1.00 |
| BACTERIA | 0 | 3.34 ± 0.10 | 3.36 ± 0.16 | 3.37 ± 0.10 | 3.38 ± 0.11 | 3.29 ± 0.03 | 3.31 ± 0.06 |
| L. pseudomesenteroides | 7 | 5.10 ± 0.13 | <1.00 | <1.00 | <1.00 | <1.00 | <1.00 |
| | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |
| BACTERIA | 0 | 3.29 ± 0.10 | 3.32 ± 0.06 | 3.40 ± 0.21 | 3.34 ± 0.15 | 3.16 ± 0.12 | 3.20 ± 0.11 |
| Lactobacillus | 7 | 5.73 ± 0.26 | <1.00 | <1.00 | <1.00 | <1.00 | <1.00 |
| acetotolerans | 14 | ND | <1.00 | <1.00 | <1.00 | <1.00 | <1.00 |
| | 21 | ND | <1.00 | <1.00 | <1.00 | <1.00 | <1.00 |
| | 28 | ND | <1.00 | <1.00 | <1.00 | <1.00 | <1.00 |
| | 60 | ND | <1.00 | <1.00 | <1.00 | <1.00 | <1.00 |

ND represents “not done”;
TNTC represents “too numerous to count.”

TABLE NINE
Evaluation of a mixture of 200 ppm benzoate, 150 ppm
sorbate, and 25 ppm EDTA against different microorganisms
at 25° C. in sucrose solutions (pH 5.0).
Levels of microorganisms are show in mean log₁₀ CFU/ml ± SD.

| | | Benzoate/Sorbate/EDTA | |
|---|---|---|---|
| | Time | concentrations (mg/L) | |
| Microorganism | (days) | 0 | 200/150/25 |
| YEAST | 0 | 3.40 ± 0.15 | 3.36 ± 0.20 |
| Zygosaccharomyces | 7 | 4.29 ± 0.32 | <1.00 |
| bailii | 14 | 7.15 ± 0.25 | <1.00 |
| | 21 | ND | <1.00 |
| | 28 | ND | <1.00 |
| | 60 | ND | <1.00 |
| YEAST | 0 | 3.42 ± 0.12 | 3.38 ± 0.31 |
| Dekkera bruxellensis | 7 | 4.00 ± 0.41 | <1.00 |
| | 14 | 6.23 ± 0.56 | <1.00 |
| | 21 | ND | <1.00 |
| | 28 | ND | <1.00 |
| | 60 | ND | <1.00 |
| YEAST | 0 | 3.42 ± 0.25 | 3.38 ± 0.10 |
| Saccharomyces | 7 | 6.82 ± 0.19 | <1.00 |
| cerevisiae | 14 | ND | <1.00 |
| | 21 | ND | <1.00 |
| | 28 | ND | <1.00 |
| | 60 | ND | <1.00 |
| YEAST | 0 | 3.36 ± 0.18 | 3.26 ± 0.24 |
| Candida krusei | 7 | 7.44 ± 0.26 | <1.00 |
| | 14 | ND | <1.00 |
| | 21 | ND | <1.00 |
| | 28 | ND | <1.00 |
| | 60 | ND | <1.00 |
| YEAST | 0 | 3.34 ± 0.25 | 3.44 ± 0.08 |
| Pichia | 7 | 5.17 ± 0.54 | <1.00 |
| membranaefaciens | 14 | 6.87 ± 0.32 | <1.00 |
| | 21 | ND | <1.00 |
| | 28 | ND | <1.00 |
| | 60 | ND | <1.00 |
| MOLD | 0 | 1.25 ± 0.21 | 1.18 ± 0.16 |
| Byssochlamys fulva | 7 | TNTC | <1.00 |
| | 14 | ND | <1.00 |
| | 21 | ND | <1.00 |
| | 28 | ND | <1.00 |
| | 60 | ND | <1.00 |
| MOLD | 0 | 2.53 ± 0.19 | 2.64 ± 0.19 |
| Neosartorya fischeri | 7 | TNTC | <1.00 |
| | 14 | ND | <1.00 |
| | 21 | ND | <1.00 |
| | 28 | ND | <1.00 |
| | 60 | ND | <1.00 |
| MOLD | 0 | 2.38 ± 0.25 | 2.31 ± 0.19 |
| Fusarium oxysporum | 7 | ND | <1.00 |
| | 14 | ND | <1.00 |
| | 21 | ND | <1.00 |
| | 28 | ND | <1.00 |
| | 60 | ND | <1.00 |
| MOLD | 0 | 2.26 ± 0.18 | 2.33 ± 0.18 |
| Penicillium italicum | 7 | TNTC | <1.00 |
| | 14 | ND | <1.00 |
| | 21 | ND | <1.00 |
| | 28 | ND | <1.00 |
| | 60 | ND | <1.00 |
| BACTERIA | 0 | 3.26 ± 0.09 | 3.28 ± 0.06 |
| Gluconacetobacter | 7 | 8.05 ± 0.18 | 2.94 ± 0.38 |
| xylinus | 14 | ND | 3.50 ± 0.35 |
| | 21 | ND | 4.61 ± 0.20 |
| | 28 | ND | 4.74 ± 0.30 |
| | 60 | ND | 7.03 ± 0.84 |
| BACTERIA | 0 | 3.52 ± 0.15 | 3.49 ± 0.03 |
| Alicyclobacillus | 7 | 3.28 ± 0.08 | <1.00 |
| acidoterrestris | 14 | 3.18 ± 0.19 | <1.00 |
| | 21 | 3.06 ± 0.08 | <1.00 |
| | 28 | 3.12 ± 0.10 | <1.00 |
| | 60 | 3.38 ± 0.18 | <1.00 |
| BACTERIA | 0 | 3.32 ± 0.05 | 3.30 ± 0.18 |
| Bacillus | 7 | 2.96 ± 0.32 | <1.00 |
| stearothermophilus | 14 | 3.06 ± 0.32 | 2.63 ± 0.72 |
| | 21 | 3.28 ± 0.39 | 2.36 ± 0.16 |
| | 28 | 3.24 ± 0.28 | 2.54 ± 0.07 |
| | 60 | 3.72 ± 022 | 4.18 ± 0.69 |
| BACTERIA | 0 | 3.36 ± 0.10 | 3.29 ± 0.25 |
| Clostridium botulinum | 7 | 8.17 ± 0.21 | <1.00 |
| | 14 | ND | <1.00 |
| | 21 | ND | <1.00 |
| | 28 | ND | <1.00 |
| | 60 | ND | <1.00 |
| BACTERIA | 0 | 3.27 ± 0.13 | 3.33 ± 0.25 |
| Clostridium | 7 | 8.06 ± 0.07 | <1.00 |
| acetobutyricum | 14 | ND | <1.00 |
| | 21 | ND | <1.00 |
| | 28 | ND | <1.00 |
| | 60 | ND | <1.00 |
| BACTERIA | 0 | 3.28 ± 0.18 | 3.31 ± 0.21 |
| Leuconostoc oenus | 7 | <1.00 | <1.00 |
| | 14 | <1.00 | <1.00 |
| | 21 | <1.00 | <1.00 |
| | 28 | <1.00 | <1.00 |
| | 60 | <1.00 | <1.00 |
| BACTERIA | 0 | 3.39 ± 0.24 | 3.40 ± 0.17 |
| L. pseudomesenteroides | 7 | 5.11 ± 0.20 | <1.00 |
| | 14 | ND | <1.00 |
| | 21 | ND | <1.00 |
| | 28 | ND | <1.00 |
| | 60 | ND | <1.00 |
| BACTERIA | 0 | 3.25 ± 0.19 | 3.28 ± 0.14 |
| Lactobacillus | 7 | 6.19 ± 0.12 | <1.00 |
| acetotolerans | 14 | ND | <1.00 |
| | 21 | ND | <1.00 |
| | 28 | ND | <1.00 |
| | 60 | ND | <1.00 |

ND represents “not done”;
TNTC represents “too numerous to count.”

TABLE TEN
Evaluation of a mixture of 200 ppm benzoate, 150 ppm sorbate, and
25 ppm EDTA against different bacteria at the optimum temperature
of each organism (25°–37° C. for mesophiles and 42°–55° C.
for thermophiles) in sucrose solution (pH 5.0).
Levels of microorganisms are show in mean log₁₀ CFU/ml ± SD.

| | | Benzoate/Sorbate/EDTA | |
|---|---|---|---|
| | | concentrations (mg/L) | |
| Microorganism | Time (days) | 0 | 200/150/25 |
| BACTERIA | 0 | 3.46 ± 0.19 | 3.42 ± 0.06 |
| Gluconacetobacter | 7 | 8.25 ± 0.14 | 2.54 ± 0.40 |
| xylinus | 14 | ND | <1.00 |
| | 21 | ND | <1.00 |
| | 28 | ND | <1.00 |
| | 60 | ND | <1.00 |
| BACTERIA | 0 | 3.39 ± 0.08 | 3.32 ± 0.12 |
| Alicyclobacillus | 7 | 3.28 ± 0.17 | <1.00 |
| acidoterrestris | 14 | 3.35 ± 0.29 | <1.00 |
| | 21 | 3.37 ± 0.28 | <1.00 |
| | 28 | 3.45 ± 0.16 | <1.00 |
| | 60 | 3.55 ± 0.18 | <1.00 |
| BACTERIA | 0 | 3.32 ± 0.16 | 3.34 ± 0.12 |
| Bacillus | 7 | 3.52 ± 0.26 | <1.00 |
| stearothermophilus | 14 | 3.48 ± 0.18 | <1.00 |
| | 21 | 3.56 ± 0.28 | <1.00 |
| | 28 | 3.63 ± 0.38 | <1.00 |
| | 60 | 3.77 ± 0.28 | <1.00 |
| BACTERIA | 0 | 3.44 ± 0.16 | 3.42 ± 0.10 |
| Clostridium botulinum | 7 | 8.15 ± 0.16 | 3.32 ± 0.07 |
| | 14 | ND | 7.79 ± 0.40 |
| | 21 | ND | ND |
| | 28 | ND | ND |
| | 60 | ND | ND |
| BACTERIA | 0 | 3.38 ± 0.15 | 3.41 ± 0.08 |
| Clostridium | 7 | 8.19 ± 0.10 | 2.45 ± 0.03 |
| acetobutyricum | 14 | ND | 2.68 ± 0.08 |
| | 21 | ND | 2.42 ± 0.22 |
| | 28 | ND | 2.54 ± 0.41 |
| | 60 | ND | 3.41 ± 0.51 |
| BACTERIA | 0 | 3.37 ± 0.24 | 3.33 ± 0.13 |
| Leuconostoc oenus | 7 | <1.00 | <1.00 |
| | 14 | <1.00 | <1.00 |
| | 21 | <1.00 | <1.00 |
| | 28 | <1.00 | <1.00 |
| | 60 | <1.00 | <1.00 |
| BACTERIA | 0 | 3.18 ± 0.19 | 3.33 ± 0.14 |
| L. pseudomesenteroides | 7 | 5.16 ± 0.10 | <1.00 |
| | 14 | ND | <1.00 |
| | 21 | ND | <1.00 |
| | 28 | ND | <1.00 |
| | 60 | ND | <1.00 |
| BACTERIA | 0 | 3.36 ± 0.10 | 3.33 ± 0.07 |
| Lactobacillus | 7 | 6.08 ± 0.08 | <1.00 |
| acetotolerans | 14 | ND | <1.00 |
| | 21 | ND | <1.00 |
| | 28 | ND | <1.00 |
| | 60 | ND | <1.00 |

ND represents “not done”;
TNTC represents “too numerous to count.”

From Tables FIVE through TEN, at a concentration of 0 ppm of Yucca or Quillaja extracts or benzoate/sorbate/EDTA, most microorganisms grew readily in the broth and sucrose model beverages. This demonstrates the ability of the inoculated microorganisms to grow in the model beverages lacking antimicrobials, which is called the positive growth control. Lack of growth of the inoculum in samples with antimicrobials is evidenced by CFU/ml values equal to or lower than the original inoculum at day 0. Delay in growth caused by antimicrobials is evidenced by lower CFU/ml values than those seen in positive growth controls. Death of the inoculum is evidenced by lower CFU/ml values in samples containing levels of Yucca or Quillaja extracts than the original inoculum at day 0. In many cases, death of inoculated microorganisms was observed. In some cases, delay in growth or no growth of inoculated microorganisms was observed.

The inventors demonstrate Saccharomyces, Zygosaccharomyces, Candida, Dekkera and Pichia are inhibited in sucrose beverage systems by triterpene saponin-rich extracts of Quillaja saponaria as well as by steroidal-rich extracts of Yucca schidigera. See Tables FIVE through EIGHT. In addition, Yucca and Quillaja extract demonstrated inhibition against microorganisms that proliferated with the combination of benzoate/sorbate/EDTA combination. For example, in Table NINE, the bacteria Gluconacetobacter xylinus grew in the sucrose containing benzoate/sorbate/EDTA, as evidenced by an increase in CFU/ml values compared to the original inoculum at day 0. In contrast, in Tables FIVE and SEVEN, this same bacteria exhibited death by the lower CFU/ml values in samples containing Yucca and Quillaja extracts than the original inoculum at day 0. The bacteria Clostridium acetobutyricum demonstrated a similar phenomena in the benzoate/sorbate/EDTA sample (Table TEN) compared to Yucca (Table SIX) and Quillaja (Table EIGHT). This demonstrates the ability of Yucca and Quillaja to act on microorganisms resistant to traditional preservatives systems in a beverage system. By being able to act on these microorganisms, it suggest that the combination of a saponin-comprising extract with an additional preservative may exhibit enhanced inhibition on microorganisms.

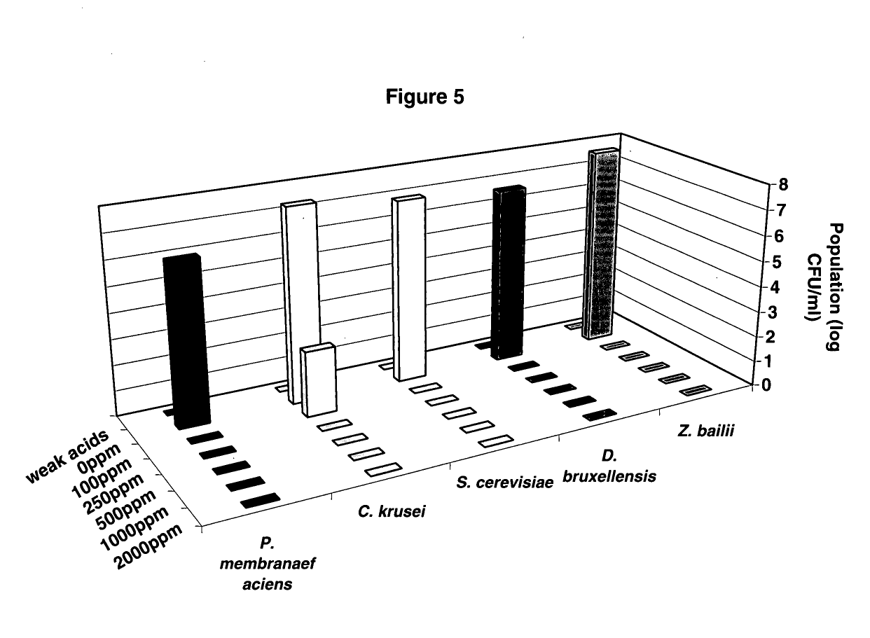

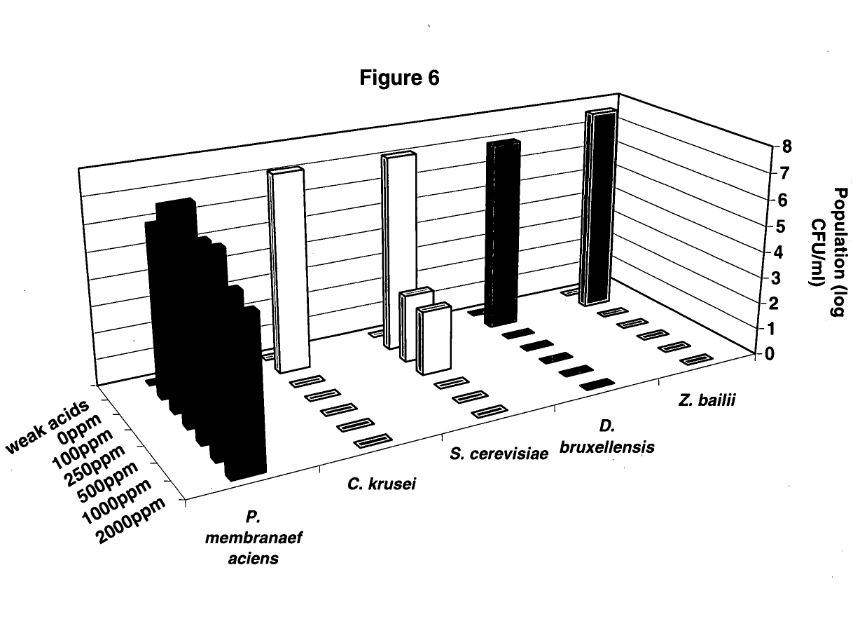

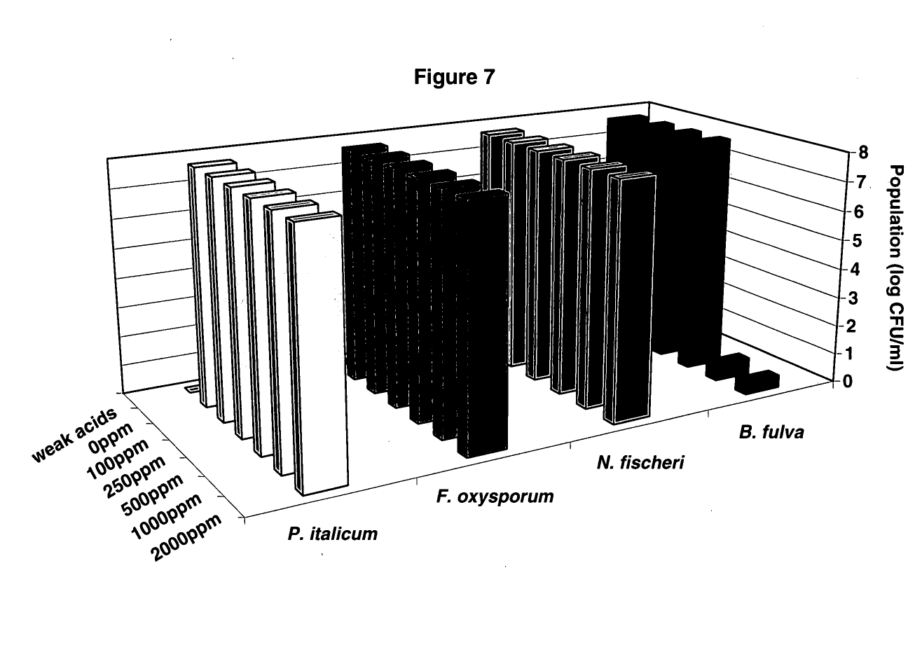

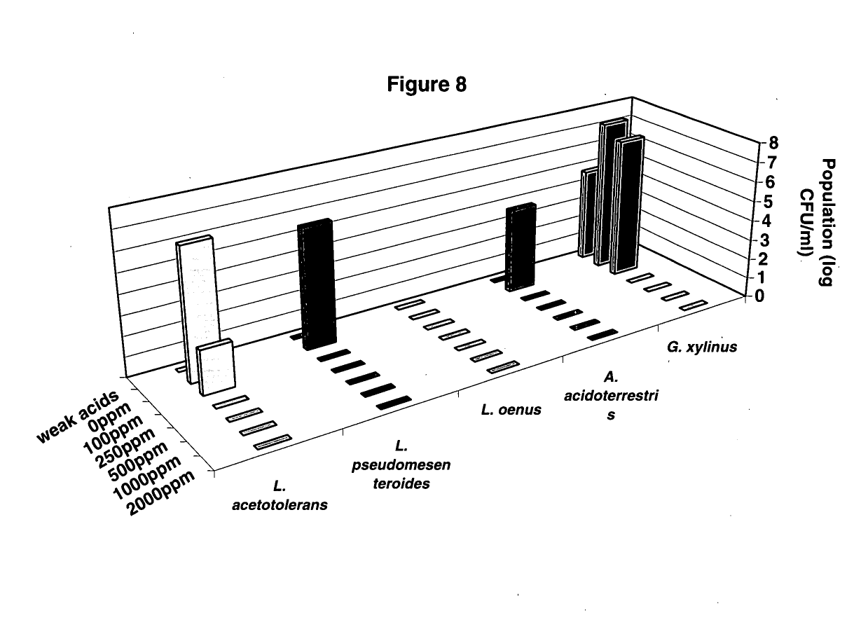

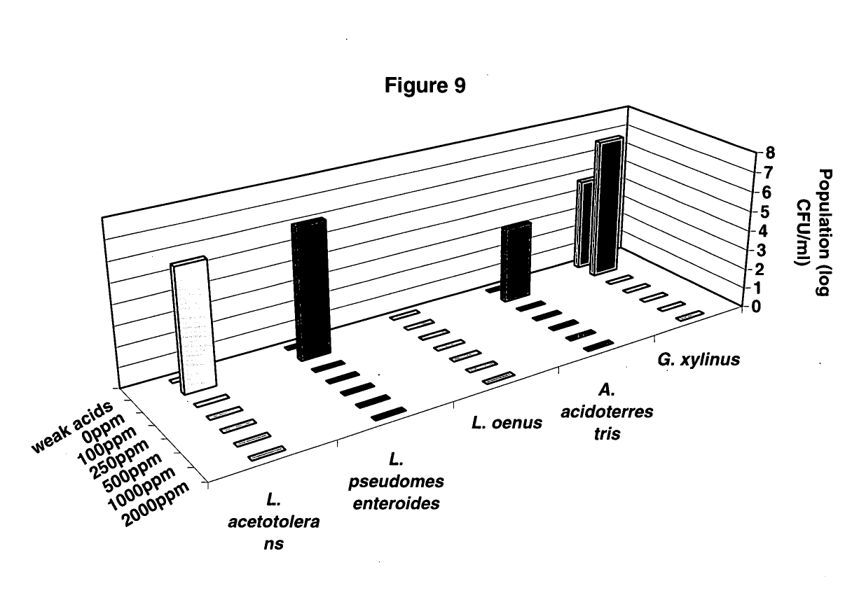

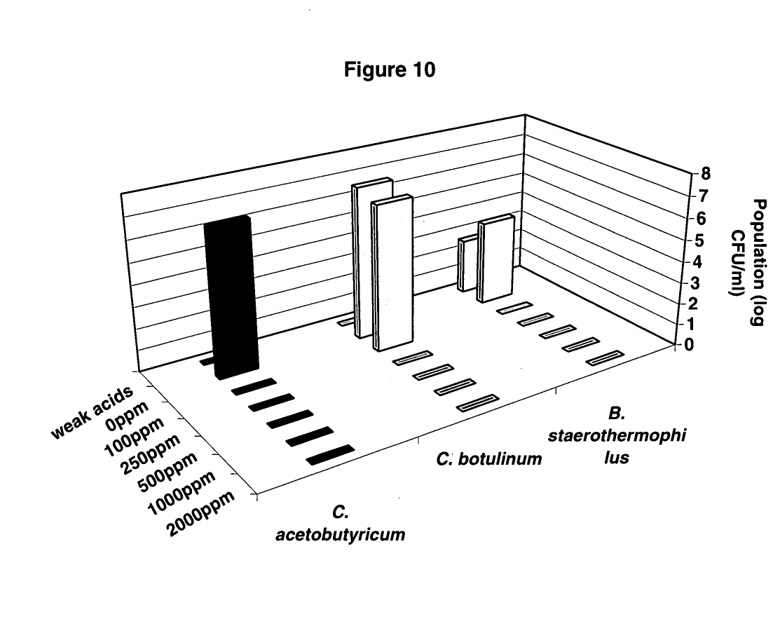

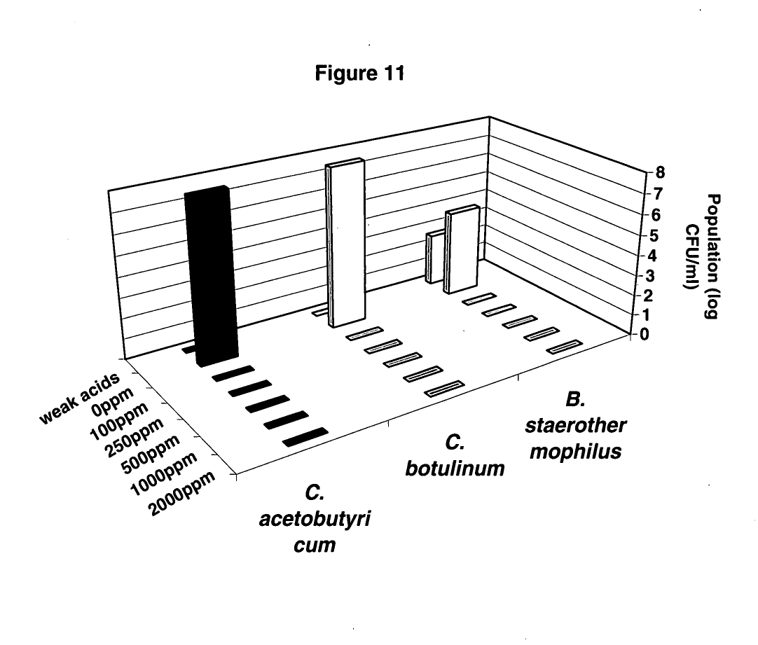

From the data in Tables FIVE, SIX, NINE and TEN, FIGS. 5, 7, 8, and 10 show the maximum populations of yeasts (FIG. 5), molds (FIG. 7), acidophilic bacteria (FIG. 8), and sporeforming bacteria (FIG. 10) reached within the span of time from day 0 to day 28 in weak acid preserved and Yucca-extract preserved solution, i.e., model beverage system. From the data in Tables SEVEN through TEN, FIGS. 6, 9, and 11 show the maximum populations of yeasts (FIG. 6), acidophilic bacteria (FIG. 9), and sporeforming bacteria (FIG. 11) reached within the span of time from day 0 to day 28 in weak acid preserved and Quillaja extract preserved sucrose solution, i.e., model beverage system.

As provided with the non-carbonated malt extract broth and sucrose testing, Yucca and Quillaja extracts were respectively examined in carbonated broth systems and carbonated sucrose systems. Those carbonated systems were used to determine if the Yucca or Quillaja extract exhibited antimicrobial activity against microorganisms such as bacteria, yeasts and/or molds, and to determine minimum inhibitory concentrations of the same. From that data, as was found for the non-carbonated malt extract broth and sucrose systems, microbial inhibition or microbial reduction of the inoculated microorganisms was generally observed. Those results were dependent at least on the level of Yucca or Quillaja, the microorganism type (bacteria, yeasts or mold), and/or the genus/species of the microorganism.

pH

The compositions of the present invention, e.g., beverages, may have a pH ranging from about 2 to about 9. Acidic beverages generally have a pH ranging from about 2 to about 4.6, whereas neutral pH beverages have a pH ranging from about 4.6 to 7.0, and basic beverages typically have a pH greater than 7.0.

It is known in the art that the pH of a beverage may be a factor in maintaining a shelf-stable beverage, as some microorganisms growth may be hindered under acidic conditions. This, however, is not the case for microorganisms such as Saccharomyces and Candida, in which case these microorganisms thrive in such an acidic environment. Utilizing a preservative of the present invention allows the composition to maintain microbial stability even in acidic conditions.

In addition, compositions of the present invention may comprise fruits and vegetables resulting in a high acid and/or tart flavors. Generally, a beverage having at least one carbohydrate in the amount ranging from 0% to 15%, by weight relative to the total composition and at least one acid ranging from 0% to 0.5%, by weight relative to the total composition can offset such acid and/or tart flavors. This range may be suitable for not only beverages but also syrups when properly diluted to form a single strength beverage.

For an acidic beverage (pH ranging from about 2 to about 4.6), the acidity of the beverage can be adjusted to and maintained within the recited range by known and conventional methods in the art. For example, the pH can be adjusted using at least one acidulant. In addition, the use of acidulants may assist in microbial inhibition at the same time as maintaining the pH of the beverage. Compositions of the present invention, however, may inherently have a desirable pH without the use of any acidulants or other components to modify the pH. Thus, the incorporation of at least one acidulant is optional in compositions of the present invention.

Mention may be made among possible acidulants, but not limited to, organic and inorganic acids to be used in adjusting the pH of a composition of the present invention such as a beverage. The acidulants may also be in an undissociated form or in their respective salt form such as potassium, sodium or hydrochloride salts. Acidulants used in the present composition may be, but not limited to, the following: citric acid, ascorbic acid, malic acid, benzoic acid, phosphoric acid, acetic acid, adipic acid, fumaric acid, gluconic acid, tartaric acid, lactic acid, propionic acid, sorbic acid, or mixtures thereof. In one embodiment, the acidulant is citric acid.

Moreover, the amounts of the acidulant(s), which may be present in the composition according to the present disclosure, are those conventionally used in compositions of the present invention such as beverages and foods. For example, the at least one acidulant may be present in an amount ranging from about 0% to about 1%, by weight relative to the composition.

Optional Preservatives

The composition of the present invention may further comprise at least one additional preservative, other than the at least one saponin-comprising extract. As used herein, the term “preservative” includes all preservatives approved for use in beverage and/or food product compositions. Mention may be made among additional preservatives such as, but not limited to, chemical preservatives (e.g., benzoates, sorbates, citrates, and salts thereof), chelating agents, (e.g., sodium hexametaphosphate, ethylenediaminetetraacetic acid (EDTA)), free fatty acids, esters and derivatives thereof, peptides, lauric arginate, cultured dextrose, neem oil, eugenol, p-cymene, thymol, carvacrol, linalool, hydroxycinnamic acid, cinnamic acid, cinnamic aldehyde, natamycin, tea tree oil, fingerroot extract, acai powder, 4-hydroxybenzyl isothiocyanate and/or white mustard seed essential oil, ferulic acid, and mixtures thereof. Additional preservatives, moreover, may include, but not limited to, lacto-antimicrobials such as lactoferrin, lactoperoxidase, lactoglobulins and lactolipids, ovo-antimicrobials such as lysozyme, ovotransferrin, ovoglobulin IgY and avidin, phyto-antimicrobials such as phyto-phenols, flavonoids, thiosulfinates, catechins, glucosinolates and agar, bacto-antimicrobials such as probiotics, nisin, pediocin, reuterin and sakacins, acid-anticmicrobials such as lactic acid, sorbic acid, acetic acid and citric acid, milieu-antimicrobials such as sodium chloride, polyphosphates, chloro-cides and ozone. The at least one additional preservative may be present in an amount not exceeding maximum mandated levels, as established by the U.S. Food and Drug Administration or other food and beverage governing bodies.

The combination of the at least one saponin-comprising extract along with the at least one additional preservative is believed to provide further inhibition against typical spoilage microorganisms, e.g., in a beverage compared to unpreserved positive growth controls. For example, the combination of the at least one saponin-comprising extract with the at least one additional preservative exhibits enhanced inhibition and/or reduction in microorganism growth compared to the use of the at least one saponin-comprising extract or the at least one additional preservative used alone in a beverage or a food.

In addition, with the use of the at least one saponin-comprising extract, it is believed that the at least one additional preservative may be used at a reduced level in comparison when the additional preservative is used alone. This may not only lead to reduction of the minimum inhibitory concentrations of these additional preservatives, but also minimize changes in flavor that can be attributed to the additional preservative. Thus, it is believed that the present inventors improve the utility of such additional preservatives.

For example, the use of at least saponin-comprising extract in conjunction with weak acid preservatives such as sorbic and/or benzoic acids and their associated salts can have the added benefit of causing inhibition or death of preservative resistant microorganisms, i.e. Zygosaccharomyces. spp., S. cerevisiae, C. krusei, and Gluconobacter spp. by e.g., serving as a surface active agent on and compromising the integrity of microbial cell walls, thereby circumventing preservative resistant mechanisms.

Optional Components

The compositions of the present invention may further comprise optional components commonly found in conventional beverages and/or food products. Such optional ingredients may be dispersed, solubilized, or otherwise mixed into or with the composition of the present invention. For example, mention may be made of conventional beverage and/or food components, such as but not limited to water, coloring agents, flavoring agents, juices, flavanoids, vitamins, minerals, proteins, sweeteners and non-caloric sweeteners, emulsifiers, carbonation components, thickeners, i.e., viscosity modifiers and bodying agents, antioxidants, anti-foaming agents, and mixtures thereof.

Water

According to one embodiment of the present invention, the composition may further comprise water. The water may be “treated water”, “purified water”, “demineralized water”, and/or “distilled water.” The water should be suitable for human consumption and the composition should not be, or should not be substantially detrimentally, affected by the inclusion of the water.

In one embodiment, water may be present in an amount ranging from about 1% to about 99.9%. The added water component may also meet certain quality standards such as biological, nutrient, and sediment criteria. For example, biological oxygen demand, water hardness, water conductivity, and/or water resistivity be may factors for consideration when formulating a beverage and/or food.

Coloring Agents

The compositions of the present invention may also further comprise at least one coloring agent. Mention may be made, among colorants, but not limited to, of FD&C dyes, FD&C lakes, and mixtures thereof. Any other colorant used in beverages and/or food products may be used. For example, a mixture of FD&C dyes or a FD&C lake dye in combination with other conventional beverage and/or food colorants may be used. Moreover, other natural coloring agents may be utilized including, for example, fruit, vegetable, and/or plant extracts such as grape, black currant, carrot, beetroot, red cabbage, and hibiscus.

Flavoring Agents

The present composition may further comprise at least one flavoring agent. The at least one flavoring agent may include, but not limited to, oils, extracts, oleoresins, essential oils, any other flavoring agent known in the art, and mixtures thereof. For example, suitable flavors include but are not limited to fruit flavors, cola flavors, tea flavors, coffee flavors, chocolate flavors, dairy flavors, coffee, tea, kola nut, ginseng, cacao pod, and mixtures thereof. Suitable oils and extracts may include, but are not limited to, vanilla extract, citrus oil and extract, and mixtures thereof. These flavors may be derived from natural sources such as juices, essential oils and extracts, or may be synthetically prepared. Moreover, the at least one flavoring agent may be a blend of various flavors such as fruits and/or vegetables.

Juices

The composition of the present invention may further comprise at least one juice. The at least one juice component can provide to the composition of the present invention beneficial characteristics such as flavor and nutrients. Although the at least one juice imparts beneficial properties to the compositions, it also can be a food source for microorganisms that have infected the composition. As a result, the use of the present invention provides for the incorporation of the at least one juice without surrendering microbial stability. Furthermore, at least one saponin-comprising extract can be incorporated into compositions such as beverages and foods without detrimentally effecting the flavor or nutrients of the at least one juice.

The at least one juice component may be derived from, but not limited to, citrus and non-citrus fruits, vegetables, botanicals, or mixtures thereof. Mention may be made, among citrus and non-citrus fruits, but not limited to, peaches, nectarines, pears, quinces, cherries, apricots, apples, plums, figs, kiwis, clementines, kumquats, minneolas, mandarins, oranges, satsumas, tangerines, tangelos, lemons, limes, grapefruits, bananas, avocados, dates, hogplums, mangos, gooseberry, star fruits, persimmons, guavas, passion fruits, papayas, pomegranates, prickly pears, blue berries, black berries, raspberries, grapes, elderberries, cantaloupes, pineapples, watermelons, currants, strawberries, cranberries, and mixtures thereof.

Mention may be made among vegetables, but not limited to, carrots, tomatoes, spinach, peppers, cabbage, sprouts, broccoli, potatoes, celery, anise, cucumbers, parsley, beets, wheat grass, asparagus, zucchini, rhubarb, turnip, rutabaga, parsnip, radish, and mixtures thereof.

Botanical juices are often obtained from, for example, but not limited to, beans, nuts, bark, leaves and roots of a plant, i.e., something other than the fruit of the plant. For example, botanical juices may impart flavors such as vanilla, coffee, tea, cola, and coca. These flavors may be derived naturally or synthetically.

Flavanoids

The present invention may optionally comprise at least one flavanoid, which is a natural substance of a class of plant secondary metabolites. Flavanoids are known to have antioxidant, anti-microbial, and anti-cancer activity. Flavaroids may be found in plants, vegetables, fruits, flowers or any other known natural source by a skilled artisan. Flavanoids may be derived from these sources by conventional means known in the art. Derivation is not limited to a single source of flavanoids, but also may include mixture of sources such as extraction from a single or mixture of vegetables. In addition, flavanoids may be prepared synthetically or by another appropriate chemical means and incorporated into the present composition. Mention may be made of flavanoids such as, but not limited to, quercetin, kaempferol, myricetin, isohammetin, catechin, and derivatives or mixtures thereof.

Vitamins and Minerals

According to the present invention, at least one supplemental vitamin and/or mineral may be optionally incorporated into compositions of the present invention. Similar to the at least one juice component, the added vitamin(s) and/or mineral(s) can also serve as a food source for the microorganisms. Historically, vitamins and minerals such as calcium, iron, and magnesium could not be fortified into a beverage composition because preservatives such as polyphosphates would bind to and inactivate the vitamin and/or mineral. This may be avoided with the preservative of at least one saponin-comprising extract and the contemplated compositions.

Mention may be made among vitamins such as, but not limited to, riboflavin, niacin, pantothenic acid, pyridoxine, cobalamins, choline bitartate, niacinamide, thiamin, folic acid, d-calcium pantothenate, biotin, vitamin A, vitamin C, one or more B-complex vitamins such as vitamin B₁ hydrochloride, vitamin B₂, vitamin B₃, vitamin B₆ hydrochloride and vitamin B₁₂, vitamin D, vitamin E acetate, vitamin K, and derivatives or mixtures thereof. Mention may be made, among minerals such as, but not limited to, calcium, zinc, iron, magnesium, manganese, copper, iodine, fluoride, selenium, and mixtures thereof. Synthetic vitamins and minerals are also contemplated within the scope of compositions of the present invention. The addition of optional vitamins and minerals should be done with such care that the flavor of the present composition may not be significantly diminished. The at least one supplemental vitamin and/or mineral may be also added to assist the consumer in meeting the U.S. Recommended Daily Intake (RDI) for vitamins and minerals.

Protein

In addition, compositions of the present invention may further comprise at least one protein component, e.g., soy protein extract. The at least one protein component may be from, for example, but not limited to, milk proteins such as casein (caseinate), whey protein, egg whites, gelatin, collagen, and mixtures thereof.

Sweetener

The compositions of the present invention may further comprise at least one sweetener chosen from nutritive sweeteners, non-nutritive sweeteners, and mixtures thereof. The at least one sweetener may be natural, artificial, or mixtures thereof. Of the nutritive (i.e., caloric) sweeteners, the present compositions may include, for example, carbohydrate sweeteners such as monosaccharides and/or disaccharides. Mention may be made among caloric sweeteners, but not limited to, fructose, sucrose, glucose, sugar alcohols, corn syrup, evaporated cane juice, rice syrups, maple syrup, black malt syrups, fruit juice concentrate, honey, agave, tapioca syrup, chicory root syrup, and mixtures thereof. The non-nutritive sweeteners may include, but are not limited to, luo han guo, stevia and derivatives thereof, erythrithol, acesulfame potassium, aspartame, neotame, saccharin, sucralose, tagatose, alitame, cyclamate, and mixtures thereof. Blends of nutritive as well as non-nutritive sweeteners are contemplated herein.

Emulsifier

The present invention optionally comprises at least one emulsifier. Any beverage and/or food grade emulsifier can be used to stabilize an emulsion. Mention may be of emulsifiers such as, but not limited to, gum acacia, modified food starches (e.g., alkenylsuccinate modified food starches), anionic polymers derived from cellulose (e.g., carboxymethylcellulose), gum ghatti, modified gum ghatti, xanthan gum, tragacanth gum, guar gum, locust bean gum, pectin, lecithin and mixtures thereof. For example, a beverage can comprises a cloud emulsion or a flavor emulsion.

For cloud emulsions, the clouding agent can comprise at least one fat or oil stabilized as an oil-in-water emulsion using a suitable food grade emulsifier. Any of a variety of fats or oils may be employed as the clouding agent, provided that the fat or oil is suitable for use in compositions such as beverages. Any suitable beverage and/or food grade emulsifier can be used that can stabilize the fat or oil clouding agent as an oil-in-water emulsion.

Flavor emulsions useful in the compositions, e.g., beverages, of the present invention comprise at least one suitable flavor oil, extract, oleoresin, essential oil and the like, known in the art for use as flavorants in beverages.

Carbonation

When compositions of the present invention are beverages, carbonation (e.g., carbon dioxide) may be further added based on techniques commonly known to the skilled artisan. For example, carbon dioxide may be added to the water introduced into the beverage or beverage concentrate. The amount of carbonation introduced into the compositions of the present invention will depend on the nature of the beverage and the desired level of carbonation.

Thickeners

Compositions of the present invention may optionally comprise at least one thickener. Mention may be made, among thickeners, i.e., viscosity modifiers and/or bodying agents, such as but not limited to cellulose compounds, gum ghatti, modified gum ghatti, guar gum, tragacanth gum, gum arabic, pectin, xanthum gum, carrageenan, locust bean gum, pectin, lecithin, and mixtures thereof.

Antioxidants

Compositions of the present invention further comprises at least one antioxidant. The at least one antioxidant may include, but not limited to, ascorbic acid, gum guar; propylgalacte, sulfite and metabisulfite salts; thiodiproprionic acid and esters thereof; spice extracts; grape seed; tea extracts; and mixtures thereof.

Amino Acids

According to the present invention, the compositions may further comprise at least one amino acid. The at least one amino acid may include, but not limited to, alanine, arginine, asparagine, cysteine, glutamine, glycine, histidine, leucine, lysine, methionine, ornithine, proline, phenylalanine, serine, threonine, tryptophan, tyrosine, valine and mixtures thereof.

Anti-Foaming Agents

The present invention may further comprise at least one anti-foaming agent. The at least one anti-foaming agent may include, but not limited to, calcium alginate, silicone polymers such as polydimethylsiloxane, and fatty acid esters such as propylene glycol fatty acid esters, glycerin fatty acids esters and sorbitan fatty acid esters, and mixtures thereof.

The amounts of these above optional components, which may be present in the compositions according to the invention, are those conventionally used in beverage and/or food product compositions. In addition, the amount of these additional components will depend upon the desired beverage and/or food product.

Preparation

The present compositions, e.g., beverages, can be made according to methods which are well known by skilled artisans in the art. For example, the beverage composition can be prepared by dispersing, dissolving, diffusing or otherwise mixing all the ingredients simultaneously together or sequentially adding ingredients based on solubility or any other parameters with the addition of water, where appropriate. This may be done with a mechanical stirrer or by homogenization techniques commonly known in the art. In addition, the composition of the present invention may be made into a liquid or dry beverage concentrate.

Microbial Evaluation

The compositions of the present invention may be evaluated to determine the microbial stability based on techniques known to those of ordinary skill in the art. For example, one way to determine microbial stability is inoculating a beverage matrix of the present invention for evaluation with a group of microorganisms such as molds, yeasts, and bacteria. These microorganisms may be those previously identified in beverages causing spoilage problems, such as those mentioned in Table ONE or any other type of yeast, mold, bacteria and/or mixtures thereof. Once the media is inoculated, periodic plate counts can be preformed to determine growth of the microorganisms. Based on the plate counts, one can determine the degree of microorganism growth in the inoculate composition, e.g., beverage. The present inventors used standard methods of enumeration in food and beverage microbiology, for example, such as those described in Ito & Pouch-Downes, Compendium of Methods for the Microbiological Examination of Foods (4th ed. Amer. Pub. Health Assoc. 2001), and those found in Notermans, et al., A User's Guide to Microbiological Challenge Testing for Ensuring the Safety and Stability of Food products, 10 Food Microbiology 145-57 (1993), the contents of which are incorporated herein by reference.

In addition, flow cytometry may also be used for growth determinations of the microorganisms. See Jay, J. M., Modern Food Microbiology (Aspen Publishers, Inc., 2000). Flow cytometry uses the principles of light scattering, light excitation and emission of fluorochrome molecules to identify and count the microorganisms. For example, a sample of the inoculated composition is injected into the center of a sheath flow. As the microorganism intercepts the light source, they scatter the light and fluorochromes are excited to a higher energy state. The higher energy state releases as a photon of light having specific properties. The light is essentially converted into electrical pulses that are then transmitted into a readable format such as a graph of viable cell count.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present disclosure. At the very least, the claims, each numerical parameter should be construed in light of the number of significant digits and ordinary rounding approaches.

Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements.

### EXAMPLES

The following examples include embodiments of beverage compositions according to the present invention. Those compositions were prepared and evaluated to determine microbial stability, i.e., the inhibition and/or reduction of microbial growth and/or microorganism death when inoculated with various microorganisms.

The following examples are considered to embody the present invention and in no way should be interpreted as limitations upon the present invention.

A noncarbonated beverage matrix was formulated. The non-carbonated beverage formulation and processing details are provided below.

A non-carbonated beverage matrix of 9 L was prepared that included:

| Ingredients | Amount |
|---|---|
| Sucrose | 10% (w/v) |
| Clear juice (apple) | 10% (w/v) |
| Orange flavor emulsion* | 0.2% (w/v) |
| Citric Acid | 0.15% (w/v) |
| Treated water | 7,168.5 ml |

*Orange flavor emulsion included water, gum Arabic, citric acid, cold pressed orange oil, and sucrose acetate isobutyrate and 10% ethanol weighting agent.

To clean laboratory bottles, 150 ml of the beverage matrix was added. Each bottle was then capped and pasteurized at 75° C. for about 12 minutes with an agitation at 100 rpm in a bath. The laboratory bottles were removed from the bath and inverted to mix. The bottles were allowed to cool to 50° C. or below. The following list of preservatives and combinations of preservatives were evaluated to assess the antimicrobial activity of the present invention:

| Bottle | |
|---|---|
| Number | Preservatives & Levels |
| 1 | Unpreserved (Control) |
| 2 | SHMP 750 ppm, benzoic 200 ppm, sorbic 150 ppm |
| 3 | SHMP 750 ppm, benzoic 200 ppm, sorbic 150 ppm, EDTA |
| | 25 ppm |
| 4 | benzoic 200 ppm, sorbic 150 ppm, EDTA 25 ppm |
| 5 | sorbic 250, EDTA 25 |
| 6 | Yucca 350 ppm, benzoic 200 ppm, sorbic 150 ppm, EDTA |
| | 25 ppm |
| 7 | Yucca 350 ppm, benzoic 200 ppm |
| 8 | Yucca 350 ppm, sorbic 200 ppm |
| 9 | Yucca 350 ppm, EDTA 25 ppm |
| 10 | Yucca 350 ppm, sorbic 250 ppm, EDTA 25 ppm |
| 11 | Yucca 350 ppm |
| 12 | Yucca 350 ppm, 25 ppm lauric arginate |
| 13 | Yucca 350 ppm, 200 ppm linalool |
| 14 | Yucca 350 ppm, 25 ppm Natamycin (50 ppm Natamax G) |
| 15 | Yucca 350 ppm, 250 ppm hydroxycinnamic acid (ferulic acid) |
| 16 | Yucca 350 ppm, 200 ppm eugenol |
| 17 | Yucca 350 ppm, 200 ppm chlorogenic acid |
| 18 | Yucca 350 ppm, 200 ppm cinnamic acid |
| 19 | Yucca 350 ppm, 200 ppm carvacrol |
| 20 | Yucca 350 ppm, p-cymene |
| 21 | Yucca 350 ppm, 250 ppm thymol |
| 22 | Yucca 350 ppm, 250 ppm ε-polylysine |
| 23 | Yucca 350 ppm, 200 ppm acai (ethanol extract) |
| 24 | Yucca 350 ppm, 40 ppm 4-HBITC |
| 25 | Yucca 350 ppm, 200 ppm monolaurin |
| 26 | Yucca 350 ppm, 200 ppm ellagic acid |
| 27 | Yucca 500 ppm, benzoic 200 ppm, sorbic 150 ppm, EDTA |
| | 25 ppm |
| 28 | Yucca 500 ppm, benzoic 200 ppm |
| 29 | Yucca 500 ppm, sorbic 200 ppm |
| 30 | Yucca 500 ppm, EDTA 25 ppm |
| 31 | Yucca 500 ppm, sorbic 250 ppm, EDTA 25 ppm |
| 32 | Yucca 500 ppm |
| 33 | Yucca 500 ppm, 25 ppm lauric arginate |
| 34 | Yucca 500 ppm, 200 ppm linalool |
| 35 | Yucca 500 ppm, 25 ppm Natamycin (50 ppm Natamax G) |
| 36 | Yucca 500 ppm, 250 ppm hydroxycinnamic acid (ferulic acid) |
| 37 | Yucca 500 ppm, 200 ppm eugenol |
| 38 | Yucca 500 ppm, 200 ppm chlorogenic acid |
| 39 | Yucca 500 ppm, 200 ppm cinnamic acid |
| 40 | Yucca 500 ppm, 200 ppm carvacrol |
| 41 | Yucca 500 ppm, 200 ppm p-cymene |
| 42 | Yucca 500 ppm, 250 ppm thymol |
| 43 | Yucca 500 ppm, 250 ppm ε-polylysine |
| 44 | Yucca 500 ppm, 200 ppm acai (ethanol extract) |
| 45 | Yucca 500 ppm, 40 ppm 4-HBITC |
| 46 | Yucca 500 ppm, 200 ppm monolaurin |
| 47 | Yucca 500 ppm, 200 ppm ellagic acid |
| 48 | 25 ppm lauric arginate |
| 49 | 200 ppm linalool |
| 50 | 25 ppm Natamycin (50 ppm Natamax G) |
| 51 | 250 ppm hydroxycinnamic acid (ferulic acid) |
| 52 | 200 ppm eugenol |
| 53 | 200 ppm chlorengic acid |
| 54 | 200 ppm cinnamic acid |
| 55 | 200 ppm carvacrol |
| 56 | 200 ppm p-cymene |
| 57 | 250 ppm thymol |
| 58 | 250 ppm ε-polylysine |
| 59 | 200 ppm acai (ethanol extract) |
| 60 | 40 ppm 4-HBITC |
| 61 | 200 ppm monolaurin |
| 62 | 200 ppm ellagic acid |

As noted above, because the preservatives and combinations of preservatives were prepared based on a volume/volume percentage, the ppm values indicated above and noted in the corresponding tables should be multiplied by the density of the crude extract of Yucca in order to obtain a more accurate ppm value. The density of the undiluted crude extract was about 1.22 g/ml. Thus, for the 350 ppm Yucca solution, the ppm value was actually 427 ppm. Likewise, the 500 ppm solution should be 610 ppm of Yucca.

In order to examine those listed preservatives and combinations of preservatives, the following microorganisms were used to prepare the various bacteria, yeast and mold inoculum:
Bacteria: Lactobacillus plantarum, L. paracasei, L. acidophilus, and Gluconobacter oxydans
Yeast: Zygosaccharomyces bailii, Saccharomyces cerevisiae, Candida krusei, Dekkera bruxellensis, Debrarymyces hansenii
Mold: Penicillium glabrum, Aspergillus ochraceus, Byssochlamys fulva, Neosartorya fischerii

Inoculum for each type of microorganism was prepared as follows:

Bacteria and Yeast Inoculum:

Bacterial cultures were prepared by placing one loop full of the four species separately into Lactobacillus MRS broth acidified to pH 3.8 with citric acid. The cultures were incubated at 35° C. for 48 h. Individual cultures of each yeast species were prepared by placing one loop full of each into pasteurized and cooled model beverage at pH 3.0. The inoculated model beverage was incubated at 25° C. for about 72 hours to enable growth of yeasts. The microorganisms were plated and counted for CFU/ml levels. A healthy yeast or bacteria culture may be around 1×10⁶ cfu/ml or greater. Individual cultures were combined such that multi-species bacterial and multi-species yeast inocula were created for inoculating test variables of the model beverage.

Mold Inoculum:

Acidified potato dextrose agar Petri dishes were spot inoculated separately with each species of mold. The plates were incubated for approximately four weeks. The spores were washed off the plates and spores were separated from fragments of hypha by centrifugation. The spores were re-suspended in phosphate buffer and populations were enumerated by surface plating on acidified potato dextrose agar or modified green yeast and mold medium. The plates were incubated at 25° C. for approximately 3 to 5 days prior to counting.

The above prepared unpreserved and preserved bottles of beverage matrix were inoculated with microorganisms, i.e., generally 1×10³ CFU/ml of yeasts, bacteria or mold (triplicate tubes per inoculum were prepared). The tubes were vortexed for 10 s and initial samples were removed from each container to represent 0 time. The microorganisms were incubated in the inoculated tubes at 25° C. At the designated time intervals, samples were monitored by spiral plating or spread plating onto malt extract agar for yeast or mold samples, or Lactobacillus MRS agar for bacteria.

The data below in Tables ELEVEN through THIRTEEN present the mean log values of the respective microorganisms at the designated time points. The data presented in Tables ELEVEN and THIRTEEN are a sampling of those preservatives and combinations of preservatives identified above. In general, the data presented below are based on the preservatives and/or combinations of preservatives pair that exhibited the better antimicrobial activity. For example, variable 22 is 350 ppm of Yucca and 250 pm of ε-polylysine and variable 43 is 500 ppm of Yucca and 250 ppm of ε-polylysine. Based on the 28 and 62 day log change values, variable 43 exhibited more of a decline in the microbial inoculum in the model beverage in comparison with variable 22. As a result, data for variable 43 is provided in Tables ELEVEN through THIRTEEN.

The 28 and 62 day log changes are reported below for the preservatives examined. Those log changes were calculated by taking the level of microorganisms at day 28 or 62 and subtracting the level of microorganisms found at day 0. If an immediate decline in microorganisms was observed at day 0 and sustained until 28 or 62 days, the log change was estimated to be −3.0 for yeast or mold, and −3.5 for bacteria. Positive values indicate an increase in microorganism growth, whereas negative values demonstrate reductions in microorganism growth.

TABLE ELEVEN
Evaluation of saponin-comprising extract alone and in combination with other
preservatives as well as other preservatives alone against different bacteria in a beverage matrix.
Level of bacteria shown in mean (3 replicates) log₁₀ CFU/ml.

| | | | | | | | | | 28 Day | 62 Day |
|---|---|---|---|---|---|---|---|---|---|---|
| Bottle | | Day of Incubation at 25 C. | | | | | | | Log | Log |
| Number | Preservatives and Level | 0 | 7 | 14 | 21 | 28 | 42 | 62 | Change | Change |
| 1 | Unpreserved | 3.49 | 4.25 | 3.66 | 3.94 | 4.53 | 4.53 | 4.35 | 1.04 | 0.86 |
| 4 | benzoic 200 ppm, sorbic | 3.51 | 4.26 | ND | 3.58 | 5.85 | 5.85 | TNTC | 2.34 | 2.34 |
| | 150 ppm, EDTA 25 ppm | | | | | | | | | |
| 6 | Yucca 350 ppm, benzoic | 3.35 | 3.44 | 3.26 | 1.50 | 1.51 | 1.14 | 1.30 | −1.84 | −2.05 |
| | 200 ppm, sorbic 150 ppm, EDTA | | | | | | | | | |
| | 25 ppm | | | | | | | | | |
| 7 | Yucca 350 ppm, benzoic | 3.34 | 3.80 | 3.68 | 4.16 | 4.72 | 4.72 | 4.66 | 1.39 | 1.32 |
| | 200 ppm | | | | | | | | | |
| 8 | Yucca 350 ppm, sorbic 200 ppm | 3.56 | 3.79 | 3.66 | 3.10 | 3.62 | 3.62 | 3.42 | 0.06 | −0.14 |
| 9 | Yucca 350 ppm, EDTA 25 ppm | 3.59 | 3.80 | 2.99 | 4.22 | 5.88 | 5.88 | TNTC | 2.29 | 2.29 |
| 11 | Yucca 350 ppm | 3.60 | 3.88 | 3.74 | 3.23 | 5.46 | 5.46 | TNTC | 1.87 | 1.87 |
| 12 | Yucca 350 ppm, 25 ppm lauric | 3.55 | 3.42 | 3.08 | 3.30 | 4.09 | 4.09 | 4.67 | 0.54 | 1.13 |
| | arginate | | | | | | | | | |
| 13 | Yucca 350 ppm, 200 ppm linalool | 3.69 | 4.32 | 3.77 | 3.17 | 5.68 | 5.68 | TNTC | 1.99 | 1.99 |
| 18 | Yucca 350 ppm, 200 ppm | 3.45 | 4.08 | 2.53 | 3.46 | 3.03 | 3.02 | 2.88 | −0.42 | −0.57 |
| | cinnamic acid | | | | | | | | | |
| 19 | Yucca 350 ppm, 200 ppm | 0.00 | 0.00 | 0.00 | 0.00 | 0.00 | 0.00 | 0.00 | −3.50 | −3.50 |
| | carvacrol | | | | | | | | | |
| 20 | Yucca 350 ppm, 200 ppm p- | 3.51 | 3.76 | 2.89 | 3.67 | 5.28 | 5.28 | TNTC | 1.77 | 1.77 |
| | cymene | | | | | | | | | |
| 25 | Yucca 350 ppm, 200 ppm | 3.54 | 3.53 | 0.00 | 3.19 | 2.09 | 2.26 | 3.09 | −1.45 | −0.45 |
| | monolaurin | | | | | | | | | |
| 32 | Yucca 500 ppm | 3.56 | 3.75 | 4.67 | 4.41 | 3.05 | 3.08 | 3.56 | −0.52 | 0.00 |
| 35 | Yucca 500 ppm, 25 ppm | 3.56 | 3.57 | 3.45 | 1.49 | 1.69 | 1.87 | 4.44 | −1.87 | 0.88 |
| | Natamycin (50 ppm Natamax G) | | | | | | | | | |
| 36 | Yucca 500 ppm, 250 ppm | 3.59 | 3.34 | 3.64 | 2.07 | 3.07 | 4.23 | 4.24 | −0.51 | 0.65 |
| | hydroxycinnamic acid (ferulic | | | | | | | | | |
| | acid) | | | | | | | | | |
| 37 | Yucca 500 ppm, 200 ppm | 3.58 | 4.18 | 3.59 | 3.27 | 2.74 | 3.32 | 4.00 | −0.84 | 0.43 |
| | eugenol | | | | | | | | | |
| 38 | Yucca 500 ppm, 200 ppm | 3.50 | 3.83 | 4.32 | 2.55 | 0.63 | 4.04 | 4.65 | −2.86 | 1.15 |
| | chlorogenic acid | | | | | | | | | |
| 42 | Yucca 500 ppm, 250 ppm thymol | 3.68 | 4.14 | 3.31 | 2.93 | 5.39 | TNTC | TNTC | 1.71 | 1.71 |
| 43 | Yucca 500 ppm, 250 ppm ε- | 3.68 | 3.88 | 4.83 | 4.33 | 6.76 | TNTC | TNTC | 3.08 | 3.08 |
| | polylysine | | | | | | | | | |
| 44 | Yucca 500 ppm, 200 ppm acai | 3.66 | 4.13 | 4.42 | 4.24 | 6.11 | TNTC | TNTC | 2.45 | 2.45 |
| | (ethanol extract) | | | | | | | | | |
| 45 | Yucca 500 ppm, 40 ppm 4-HBITC | 3.60 | 4.18 | 3.88 | 4.11 | 6.24 | TNTC | TNTC | 2.64 | 2.64 |
| 47 | Yucca 500 ppm, 200 ppm ellagic | 3.60 | 3.78 | 3.82 | 2.51 | 3.12 | 3.91 | 4.56 | −0.49 | 0.95 |
| | acid | | | | | | | | | |
| 48 | 25 ppm lauric arginate | 3.61 | 4.13 | 2.88 | 2.82 | 1.10 | 3.69 | 3.77 | −2.50 | 0.16 |
| 49 | 200 ppm linalool | 3.52 | 4.03 | 3.89 | 2.60 | 1.18 | 2.62 | 4.51 | −2.34 | 0.99 |
| 50 | 25 ppm Natamycin (50 ppm | 3.55 | 3.63 | 2.97 | 2.22 | 2.62 | 2.76 | 3.10 | −0.93 | −0.45 |
| | Natamax G) | | | | | | | | | |
| 51 | 250 ppm hydroxycinnamic acid | 3.49 | 4.56 | 4.24 | 3.70 | 5.08 | TNTC | TNTC | 1.59 | 1.59 |
| | (ferulic acid) | | | | | | | | | |
| 52 | 200 ppm eugenol | 3.38 | 0.97 | 0.79 | 1.48 | 0.96 | 2.41 | 3.61 | −2.42 | 0.23 |
| 53 | 200 ppm chlorogenic acid | 3.48 | 3.67 | 3.50 | 3.74 | 4.29 | TNTC | TNTC | 0.81 | 0.81 |
| 54 | 200 ppm cinnamic acid | 3.67 | 2.79 | 1.44 | 0.00 | 0.00 | 0.00 | 0.73 | −3.67 | −2.93 |
| 55 | 200 ppm carvacrol | 1.48 | 0.00 | 0.00 | 0.73 | 0.00 | 0.00 | 0.00 | −1.48 | −1.48 |
| 56 | 200 ppm p-cymene | 3.39 | 3.18 | 2.81 | 2.21 | 1.10 | 0.00 | 0.00 | −2.29 | −3.39 |
| 57 | 250 ppm thymol | 3.38 | 0.77 | 0.43 | 0.33 | 0.00 | 0.00 | 0.00 | −3.38 | −3.38 |
| 58 | 250 ppm ε-polylysine | 3.56 | 3.87 | 4.60 | 4.76 | 3.93 | 4.64 | 4.71 | 0.38 | 1.16 |
| 59 | 200 ppm acai (ethanol extract) | 3.41 | 1.89 | 0.00 | 0.00 | 0.00 | 0.00 | 0.00 | −3.41 | −3.41 |
| 60 | 40 ppm 4-HBITC | 3.32 | 3.07 | 0.00 | 0.00 | 0.00 | 0.00 | 0.00 | −3.32 | −3.32 |
| 61 | 200 ppm monolaurin | 3.49 | 2.81 | 1.87 | 0.00 | 0.00 | 0.00 | 0.00 | −3.49 | −3.49 |
| 62 | 200 ppm ellagic acid | 3.26 | 3.36 | 1.94 | 1.51 | 1.36 | 0.00 | 0.00 | −1.90 | −3.26 |

TABLE TWELVE
Evaluation of saponin-comprising extract alone and in combination with other
preservatives as well as other preservatives alone against different yeasts in a beverage matrix.
Level of yeast shown in mean log₁₀ CFU/ml.

| | | | | | | | | | 28 Day | 62 Day |
|---|---|---|---|---|---|---|---|---|---|---|
| Bottle | Preservatives | Day of Incubation at 25° C. | | | | | | | Log | Log |
| Number | and Level | 0 | 7 | 14 | 21 | 28 | 42 | 62 | Change | Change |
| 1 | Unpreserved | 2.73 | 4.54 | 7.00 | TNTC | TNTC | TNTC | TNTC | 4.27 | 4.27 |
| 4 | benzoic 200 ppm, | 2.77 | 4.00 | . | 3.31 | 7.00 | 7.00 | TNTC | 4.23 | 4.23 |
| | sorbic 150 ppm, EDTA | | | | | | | | | |
| | 25 ppm | | | | | | | | | |
| 6 | Yucca 350 ppm, | 2.54 | 0.59 | 1.00 | 0.49 | 0.00 | 0.78 | 3.08 | −2.54 | 0.54 |
| | benzoic 200 ppm, | | | | | | | | | |
| | sorbic 150 ppm, EDTA | | | | | | | | | |
| | 25 ppm | | | | | | | | | |
| 7 | Yucca 350 ppm, | 2.93 | 0.00 | 0.00 | 0.00 | 0.00 | 0.00 | 0.00 | −2.93 | −2.93 |
| | benzoic 200 ppm | | | | | | | | | |
| 8 | Yucca 350 ppm, | 2.73 | 0.00 | 0.00 | 0.00 | 0.82 | 0.00 | 1.10 | −1.91 | −1.63 |
| | sorbic 200 ppm | | | | | | | | | |
| 9 | Yucca 350 ppm, | 2.79 | 2.39 | 2.09 | 2.92 | 0.00 | 2.08 | 1.96 | −2.79 | −0.82 |
| | EDTA 25 ppm | | | | | | | | | |
| 11 | Yucca 350 ppm | 3.11 | 1.19 | 0.00 | 0.00 | 0.00 | 0.00 | 0.00 | −3.11 | −3.11 |
| 12 | Yucca 350 ppm, | 0.00 | 0.00 | 0.00 | 0.00 | 0.00 | 0.00 | 0.00 | −3.00 | −3.00 |
| | 25 ppm lauric arginate | | | | | | | | | |
| 13 | Yucca 350 ppm, | 2.85 | 0.00 | 0.00 | 0.00 | 0.00 | 0.00 | 0.00 | −2.85 | −2.85 |
| | 200 ppm linalool | | | | | | | | | |
| 18 | Yucca 350 ppm, | 2.91 | 0.97 | 0.00 | 0.00 | 0.00 | 0.00 | 0.00 | −2.91 | −2.91 |
| | 200 ppm cinnamic | | | | | | | | | |
| | acid | | | | | | | | | |
| 19 | Yucca 350 ppm, | 1.90 | 0.00 | 0.33 | 0.33 | 0.00 | 0.00 | 0.00 | −3.00 | −3.00 |
| | 200 ppm carvacrol | | | | | | | | | |
| 20 | Yucca 350 ppm, | 2.60 | 0.00 | 0.00 | 0.00 | 0.00 | 0.00 | 0.00 | −2.60 | −2.60 |
| | 200 ppm p-cymene | | | | | | | | | |
| 25 | Yucca 350 ppm, | 2.73 | 0.92 | 0.00 | 0.00 | 1.00 | 0.70 | 0.97 | −1.73 | −1.76 |
| | 200 ppm monolaurin | | | | | | | | | |
| 32 | Yucca 500 ppm | 2.72 | 0.00 | 0.00 | 0.00 | 0.00 | 0.00 | 0.33 | −2.72 | −2.38 |
| 35 | Yucca 500 ppm, | 1.90 | 0.00 | 0.00 | 0.00 | 0.00 | 0.00 | 0.00 | −1.90 | −1.90 |
| | 25 ppm Natamycin | | | | | | | | | |
| | (50 ppm Natamax G) | | | | | | | | | |
| 36 | Yucca 500 ppm, | 2.72 | 0.00 | 0.00 | 0.00 | 0.00 | 0.00 | 0.00 | −2.72 | −2.72 |
| | 250 ppm | | | | | | | | | |
| | hydroxycinnamic acid | | | | | | | | | |
| | (ferulic acid) | | | | | | | | | |
| 37 | Yucca 500 ppm, | 2.40 | 0.00 | 0.00 | 0.00 | 0.00 | 0.00 | 0.00 | −2.40 | −2.40 |
| | 200 ppm eugenol | | | | | | | | | |
| 38 | Yucca 500 ppm, | 2.58 | 0.00 | 0.00 | 0.00 | 0.00 | 0.00 | 0.00 | −2.58 | −2.58 |
| | 200 ppm chlorogenic | | | | | | | | | |
| | acid | | | | | | | | | |
| 42 | Yucca 500 ppm, | 2.15 | 0.33 | 0.00 | 0.00 | 0.00 | 0.00 | 0.00 | −2.15 | −2.15 |
| | 250 ppm thymol | | | | | | | | | |
| 43 | Yucca 500 ppm, | 1.60 | 0.00 | 0.65 | 0.00 | 0.00 | 0.00 | 0.00 | −3.00 | −3.00 |
| | 250 ppm ε-polylysine | | | | | | | | | |
| 44 | Yucca 500 ppm, | 2.23 | 0.00 | 0.00 | 0.00 | 0.00 | 0.00 | 0.00 | −2.23 | −2.23 |
| | 200 ppm acai (ethanol | | | | | | | | | |
| | extract) | | | | | | | | | |
| 45 | Yucca 500 ppm, | 2.51 | 0.00 | 0.00 | 0.00 | 0.00 | 0.00 | 0.00 | −2.51 | −2.51 |
| | 40 ppm 4-HBITC | | | | | | | | | |
| 47 | Yucca 500 ppm, | 2.32 | 1.13 | 0.82 | 0.79 | 0.57 | 1.01 | 1.00 | −1.76 | −1.32 |
| | 200 ppm ellagic acid | | | | | | | | | |
| 48 | 25 ppm lauric arginate | 2.04 | 3.29 | 2.71 | 4.08 | 5.41 | 7.00 | TNTC | 3.37 | 4.96 |
| 49 | 200 ppm linalool | 2.64 | 4.00 | 7.00 | TNTC | TNTC | TNTC | TNTC | 4.36 | 4.36 |
| 50 | 25 ppm Natamycin | 1.30 | 0.00 | 0.00 | 0.00 | 0.00 | 0.00 | 0.00 | −3.00 | −3.00 |
| | (50 ppm Natamax G) | | | | | | | | | |
| 51 | 250 ppm | 2.63 | 4.00 | 7.00 | TNTC | TNTC | TNTC | TNTC | 4.37 | 4.37 |
| | hydroxycinnamic acid | | | | | | | | | |
| | (ferulic acid) | | | | | | | | | |
| 52 | 200 ppm eugenol | 2.65 | 4.00 | 3.60 | 4.48 | 5.29 | 7.00 | TNTC | 2.64 | 4.35 |
| 53 | 200 ppm chlorogenic | 2.73 | 4.00 | 7.00 | TNTC | TNTC | TNTC | TNTC | 4.27 | 4.27 |
| | acid | | | | | | | | | |
| 54 | 200 ppm cinnamic | 2.70 | 2.13 | 1.01 | 3.96 | 0.67 | 3.10 | 4.17 | −2.03 | 1.47 |
| | acid | | | | | | | | | |
| 55 | 200 ppm carvacrol | 2.04 | 1.08 | 0.00 | 0.78 | 0.53 | 0.83 | 1.61 | −1.51 | −0.44 |
| 56 | 200 ppm p-cymene | 2.75 | 4.00 | 7.00 | TNTC | TNTC | TNTC | TNTC | 4.25 | 4.25 |
| 57 | 250 ppm thymol | 2.70 | 4.00 | 7.00 | TNTC | TNTC | TNTC | TNTC | 4.30 | 4.30 |
| 58 | 250 ppm ε-polylysine | 1.95 | 0.49 | 2.82 | 4.09 | 4.70 | 7.00 | TNTC | 2.74 | 5.05 |
| 59 | 200 ppm acai (ethanol | 2.95 | 4.00 | 7.00 | TNTC | TNTC | TNTC | TNTC | 4.05 | 4.05 |
| | extract) | | | | | | | | | |
| 60 | 40 ppm 4-HBITC | 2.40 | 4.00 | 7.00 | TNTC | TNTC | TNTC | TNTC | 4.60 | 4.60 |
| 61 | 200 ppm monolaurin | 2.61 | 4.00 | 7.00 | TNTC | TNTC | TNTC | TNTC | 4.39 | 4.39 |
| 62 | 200 ppm ellagic acid | 2.65 | 4.00 | 7.00 | TNTC | TNTC | TNTC | TNTC | 4.35 | 4.35 |

TABLE THIRTEEN
Evaluation of saponin-comprising extract alone and in combination with other
preservatives as well as other preservatives alone against different mold in a beverage matrix.
Level of mold shown in mean log₁₀ CFU/ml.

| | | | | | | | | | 28 Day | 62 Day |
|---|---|---|---|---|---|---|---|---|---|---|
| Bottle | | Day of Incubation at 25° C. | | | | | | | Log | Log |
| Number | Preservatives and Level | 0 | 7 | 14 | 21 | 28 | 42 | 62 | Change | Change |
| 1 | Unpreserved | 2.68 | 4.00 | TNTC | TNTC | TNTC | TNTC | TNTC | 1.32 | 1.32 |
| 4 | benzoic 200 ppm, sorbic 150 ppm, | 2.60 | 1.74 | 2.35 | 2.53 | 0.87 | 3.21 | 3.10 | −1.73 | 0.50 |
| | EDTA 25 ppm | | | | | | | | | |
| 6 | Yucca 350 ppm, benzoic 200 ppm, | 2.77 | 2.17 | 1.98 | 2.59 | 1.88 | 2.80 | 3.36 | −0.89 | 0.59 |
| | sorbic 150 ppm, EDTA 25 ppm | | | | | | | | | |
| 7 | Yucca 350 ppm, benzoic 200 ppm | 2.78 | 1.33 | 2.85 | 2.39 | 0.97 | 3.33 | 3.30 | −1.81 | 0.53 |
| 8 | Yucca 350 ppm, sorbic 200 ppm | 2.81 | 2.01 | 1.24 | 0.95 | 0.87 | 1.03 | 1.05 | −1.94 | −1.77 |
| 9 | Yucca 350 ppm, EDTA 25 ppm | 3.02 | 0.86 | 2.67 | 4.00 | TNTC | TNTC | TNTC | −0.35 | 0.98 |
| 11 | Yucca 350 ppm | 2.65 | 1.26 | 2.67 | 4.00 | TNTC | TNTC | TNTC | 1.35 | 1.35 |
| 12 | Yucca 350 ppm, 25 ppm lauric | 2.65 | 2.72 | 4.00 | TNTC | TNTC | TNTC | TNTC | 1.35 | 1.35 |
| | arginate | | | | | | | | | |
| 13 | Yucca 350 ppm, 200 ppm linalool | 2.79 | 2.59 | 0.00 | 1.00 | 2.40 | 4.00 | TNTC | −0.39 | 1.21 |
| 18 | Yucca 350 ppm, 200 ppm cinnamic | 2.84 | 2.37 | 2.67 | 2.55 | 0.87 | 2.67 | 4.00 | −1.97 | 1.16 |
| | acid | | | | | | | | | |
| 19 | Yucca 350 ppm, 200 ppm carvacrol | 2.60 | 1.42 | 0.33 | 0.00 | 0.00 | 0.00 | 0.43 | −2.60 | −2.60 |
| 20 | Yucca 350 ppm, 200 ppm p-cymene | 2.79 | 2.94 | 4.00 | TNTC | TNTC | TNTC | TNTC | 1.21 | 1.21 |
| 25 | Yucca 350 ppm, 200 ppm monolaurin | 2.88 | 2.19 | 4.00 | TNTC | TNTC | TNTC | TNTC | 1.12 | 1.12 |
| 32 | Yucca 500 ppm | 2.82 | 1.37 | 4.00 | TNTC | TNTC | TNTC | TNTC | 1.18 | 1.18 |
| 35 | Yucca 500 ppm, 25 ppm Natamycin | 2.72 | 0.33 | 0.00 | 0.00 | 0.00 | 0.00 | 0.00 | −2.72 | −2.72 |
| | (50 ppm Natamax G) | | | | | | | | | |
| 36 | Yucca 500 ppm, 250 ppm | 2.74 | 3.28 | 4.00 | TNTC | TNTC | TNTC | TNTC | 1.26 | 1.26 |
| | hydroxycinnamic acid (ferulic acid) | | | | | | | | | |
| 37 | Yucca 500 ppm, 200 ppm eugenol | 2.77 | 2.23 | 2.04 | 3.02 | 3.24 | 4.00 | 7.00 | 0.47 | 1.23 |
| 38 | Yucca 500 ppm, 200 ppm chlorogenic | 2.88 | 2.36 | 4.00 | TNTC | TNTC | TNTC | TNTC | 1.12 | 1.12 |
| | acid | | | | | | | | | |
| 42 | Yucca 500 ppm, 250 ppm thymol | 2.85 | 2.15 | 4.00 | TNTC | TNTC | TNTC | TNTC | 1.15 | 1.15 |
| 43 | Yucca 500 ppm, 250 ppm ε-polylysine | 2.66 | 2.79 | 4.00 | TNTC | TNTC | TNTC | TNTC | 1.34 | 1.34 |
| 44 | Yucca 500 ppm, 200 ppm acai | 2.72 | 2.47 | 4.00 | TNTC | TNTC | TNTC | TNTC | 1.28 | 1.28 |
| | (ethanol extract) | | | | | | | | | |
| 45 | Yucca 500 ppm, 40 ppm 4-HBITC | 2.85 | 2.19 | 4.00 | TNTC | TNTC | TNTC | TNTC | 1.15 | 1.15 |
| 47 | Yucca 500 ppm, 200 ppm ellagic acid | 2.70 | 3.18 | 4.00 | TNTC | TNTC | TNTC | TNTC | 1.30 | 1.30 |
| 48 | 25 ppm lauric arginate | 2.73 | 1.33 | 0.00 | 0.00 | 0.00 | 0.00 | 0.00 | −2.73 | −2.73 |
| 49 | 200 ppm linalool | 0.00 | 1.33 | 0.00 | 0.00 | 0.00 | 0.00 | 0.00 | −3.00 | −3.00 |
| 50 | 25 ppm Natamycin (50 ppm Natamax | 2.90 | 0.67 | 0.00 | 0.00 | 0.00 | 0.00 | 0.00 | −2.90 | −2.90 |
| | G) | | | | | | | | | |
| 51 | 250 ppm hydroxycinnamic acid | 2.64 | 4.00 | TNTC | TNTC | TNTC | TNTC | TNTC | 1.36 | 1.36 |
| | (ferulic acid) | | | | | | | | | |
| 52 | 200 ppm eugenol | 2.66 | 2.55 | 4.00 | TNTC | TNTC | TNTC | TNTC | 1.34 | 1.34 |
| 53 | 200 ppm chlorogenic acid | 2.66 | 4.00 | TNTC | TNTC | TNTC | TNTC | TNTC | 1.34 | 1.34 |
| 54 | 200 ppm cinnamic acid | 2.91 | 0.33 | 0.00 | 0.00 | 0.00 | 0.00 | 0.00 | −2.91 | −2.91 |
| 55 | 200 ppm carvacrol | 2.18 | 0.87 | 0.00 | 0.00 | 0.00 | 0.00 | 0.63 | −2.18 | −1.54 |
| 56 | 200 ppm p-cymene | 2.76 | 3.60 | 4.00 | TNTC | TNTC | TNTC | TNTC | 1.24 | 1.24 |
| 57 | 250 ppm thymol | 2.75 | 2.10 | 4.00 | TNTC | TNTC | TNTC | TNTC | 1.25 | 1.25 |
| 58 | 250 ppm ε-polylysine | 2.96 | 4.00 | TNTC | TNTC | TNTC | TNTC | TNTC | 1.04 | 1.04 |
| 59 | 200 ppm acai (ethanol extract) | 2.99 | 4.00 | TNTC | TNTC | TNTC | TNTC | TNTC | 1.01 | 1.01 |
| 60 | 40 ppm 4-HBITC | 2.88 | 4.00 | TNTC | TNTC | TNTC | TNTC | TNTC | 1.12 | 1.12 |
| 61 | 200 ppm monolaurin | 2.93 | 4.00 | TNTC | TNTC | TNTC | TNTC | TNTC | 1.07 | 1.07 |
| 62 | 200 ppm ellagic acid | 2.82 | 4.00 | TNTC | TNTC | TNTC | TNTC | TNTC | 1.18 | 1.18 |

From Tables ELEVEN through THIRTEEN, variable number 1 served as the unpreserved positive-growth control and variable numbers 4 and 48-62 serve as preservative variables demonstrating the activity of the at least one additional preservative alone in a beverage system without the use of at least one saponin comprising extract. Variable numbers 6-10, 12-31, and 33-47 demonstrate the activity of the at least one additional preservative in a beverage system with the combined use of at least one saponin-comprising extract. Variables 11 and 32 represent the activity of the at least one saponin-comprising extract alone in a beverage system without the use of an additional preservative. Microbial stability, extended microbial stability, as well as microbial reduction and enhanced microbial reduction was demonstrated with preservatives according to the present invention in microorganisms chosen from bacteria, yeasts and molds. Those results were at least dependent upon at least on the level and/or combination of preservatives, the microorganism type (bacteria, yeasts or mold), and/or the genus of the microorganism.

For example, in Table ELEVEN, at least variable numbers 8 and 12 exhibited microbial stability by having no greater or equal to a 1.0 log increase from day 0 to day 28. At least variable number 6, however, exhibited microbial reduction by having greater than a 1.0 log decline within 28 days in comparison to the inocula at day 0. Extended microbial stability was observed in at least variables 25 and 32, where there was no greater or equal to a 1.0 log increase from day 0 to day 62.

In Table TWELVE, the majority of variables preserved according to the present invention exhibited microbial reduction, i.e., greater than a 1.0 log decline within 28 days in comparison to the inocula at day 0, while some variables preserved according to the present invention demonstrated extended microbial stability. Several variables including but not limited to 7, 11, 12, 13, 18, and 19 exhibited enhanced reduction, i.e., complete decline of inocula.

From Table THIRTEEN, at least variable numbers 6 and 9 exhibited microbial stability, whereas at least variable numbers 6, 7, and 9 displayed extended microbial stability and at least variable number 8 demonstrated microbial inhibition. Further, variable numbers 19 and 35 displayed enhanced microbial reduction.

What is claimed is:

1. A preservative composition comprising at least one saponin-comprising extract, wherein the preservative composition achieves microbial stability of at least one microorganism chosen from mold, yeast and bacteria in a beverage or a food.

2. The composition according to claim 1, wherein the preservative composition achieves extended microbial stability in a beverage or food.

3. The composition according to claim 1, wherein the preservative composition achieves microbial reduction in a beverage or a food.

4. The composition according to claim 1, wherein the preservative composition achieves enhanced microbial reduction in a beverage or a food.

5. The composition according to claim 1, wherein the at least one saponin-comprising extract is present in an amount ranging from about 50 ppm to about 20,000 about ppm.

6. The composition according to claim 5, wherein the at least one saponin-comprising extract is present in an amount ranging from about 250 ppm to about 5,000 ppm.

7. The composition according to claim 6, wherein the at least one saponin-comprising extract is present in an amount ranging from about 250 ppm to about 1,000 ppm.

8. The composition according to claim 5, wherein the at least one saponin-comprising extract is present in an amount ranging from about 100 ppm to about 1,000 ppm.

9. The composition according to claim 7, wherein the at least one saponin-comprising extract is present in an amount ranging from about 250 ppm to about 750 ppm.

10. The composition according to claim 1, further comprising at least one additional preservative.

11. The composition according to claim 10, wherein the at least one additional preservative is chosen from weak acids and salts thereof, sodium hexametaphosphate, ethylenediaminetetraacetic acid, free fatty acids, esters and derivatives thereof, peptides, lauric arginate, cultured dextrose, neem oil, eugenol, p-cymene, thymol, carvacrol, linalool, hydroxycinnamic acid, cinnamic acid, cinnamic aldehyde, natamycin, tea tree oil, fingerroot extract, acai powder, 4-hydroxybenzyl isothiocyanate and/or white mustard seed essential oil, ferulic acid, and mixtures thereof.

12. The composition according to claim 1, wherein the at least one saponin-comprising extract is derived from soya, beans, peas, oat, Solanum and Allium species, tomato, asparagus, tea, peanut, spinach, sugar beet, yam, blackberry, liquorice root, primula root, senega root, Quillaja, Yucca, Gyposphila, and mixtures thereof.

13. The composition according to claim 11, wherein the at least one saponin-comprising extract is derived from Yucca schidigera, Quillaja saponaria and mixtures thereof.

14. A preservative composition comprising an effective amount of at least one saponin-comprising extract and at least one additional preservative, wherein the preservative composition achieves microbial stability of at least one microorganism chosen from mold, yeast and bacteria in a beverage or a food.

15. The composition according to claim 14, wherein the preservative composition achieves extended microbial stability in a beverage or food.

16. The composition according to claim 14, wherein the preservative composition achieves microbial reduction in a beverage or a food.

17. The composition according to claim 14, wherein the preservative composition achieves enhanced microbial reduction in a beverage or a food.

18. The composition according to claim 14, wherein the at least one saponin-comprising extract is present in an amount ranging from about 50 ppm to about 20,000 about ppm.

19. The composition according to claim 18, wherein the at least one saponin-comprising extract is present in an amount ranging from about 250 ppm to about 5,000 ppm.

20. The composition according to claim 19, wherein the at least one saponin-comprising extract is present in an amount ranging from about 250 ppm to about 1,000 ppm.

21. The composition according to claim 18, wherein the at least one saponin-comprising extract is present in an amount ranging from about 100 ppm to about 1,000 ppm.

22. The composition according to claim 20, wherein the at least one saponin-comprising extract is present in an amount ranging from about 250 ppm to about 750 ppm.

23. The composition according to claim 14, wherein the at least one additional preservative is chosen from weak acids and salts thereof, sodium hexametaphosphate, ethylenediaminetetraacetic acid, free fatty acids, esters and derivatives thereof, peptides, lauric arginate, cultured dextrose, neem oil, eugenol, p-cymene, thymol, carvacrol, linalool, hydroxycinnamic acid, cinnamic acid, cinnamic aldehyde, natamycin, tea tree oil, fingerroot extract, acai powder, 4-hydroxybenzyl isothiocyanate and/or white mustard seed essential oil, ferulic acid, and mixtures thereof.

24. The composition according to claim 14, wherein the at least one saponin-comprising extract is derived from soya, beans, peas, oat, Solanum and Allium species, tomato, asparagus, tea, peanut, spinach, sugar beet, yam, blackberry, liquorice root, primula root, senega root, Quillaja, Yucca, Gyposphila, and mixtures thereof.

25. The composition according to claim 24, wherein the at least one saponin-comprising extract is derived from Yucca schidigera, Quillaja saponaria and mixtures thereof.

26. A beverage comprising a preservative composition comprising at least one saponin-comprising extract, wherein the preservative composition achieves microbial stability of at least one microorganism chosen from mold, yeast and bacteria in a beverage or a food.

27. The composition according to claim 26, wherein the preservative composition achieves extended microbial stability in a beverage or food.

28. The composition according to claim 26, wherein the preservative composition achieves microbial reduction in a beverage or a food.

29. The composition according to claim 26, wherein the preservative composition achieves enhanced microbial reduction in a beverage or a food.

30. The composition according to claim 26, wherein the at least one saponin-comprising extract is present in an amount ranging from about 50 ppm to about 20,000 about ppm.

31. The composition according to claim 30, wherein the at least one saponin-comprising extract is present in an amount ranging from about 250 ppm to about 5,000 ppm.

32. The composition according to claim 31, wherein the at least one saponin-comprising extract is present in an amount ranging from about 250 ppm to about 1,000 ppm.

33. The composition according to claim 30, wherein the at least one saponin-comprising extract is present in an amount ranging from about 100 ppm to about 1,000 ppm.

34. The composition according to claim 32, wherein the at least one saponin-comprising extract is present in an amount ranging from about 250 ppm to about 750 ppm.

35. The composition according to claim 26, further comprising at least one additional preservative.

36. The composition according to claim 35, wherein the at least one additional preservative is chosen from weak acids and salts thereof, sodium hexametaphosphate, ethylenediaminetetraacetic acid, free fatty acids, esters and derivatives thereof, peptides, lauric arginate, cultured dextrose, neem oil, eugenol, p-cymene, thymol, carvacrol, linalool, hydroxycinnamic acid, cinnamic acid, cinnamic aldehyde, natamycin, tea tree oil, fingerroot extract, acai powder, 4-hydroxybenzyl isothiocyanate and/or white mustard seed essential oil, ferulic acid, and mixtures thereof.

37. The composition according to claim 26, wherein the at least one saponin-comprising extract is derived from soya, beans, peas, oat, Solanum and Allium species, tomato, asparagus, tea, peanut, spinach, sugar beet, yam, blackberry, liquorice root, primula root, senega root, Quillaja, Yucca, Gyposphila, and mixtures thereof.

38. The composition according to claim 37, wherein the at least one saponin-comprising extract is derived from Yucca schidigera, Quillaja saponaria and mixtures thereof.

39. A beverage comprising a preservative composition comprising at least one saponin-comprising extract and at least one additional preservative, wherein the preservative composition achieves microbial stability of at least one microorganism chosen from mold, yeast and bacteria in a beverage or a food.

40. The composition according to claim 39, wherein the preservative composition achieves extended microbial stability in a beverage or food.

41. The composition according to claim 39, wherein the preservative composition achieves microbial reduction in a beverage or a food.

42. The composition according to claim 39, wherein the preservative composition achieves enhanced microbial reduction in a beverage or a food.

43. The composition according to claim 39, wherein the at least one saponin-comprising extract is present in an amount ranging from about 50 ppm to about 20,000 about ppm.

44. The composition according to claim 43, wherein the at least one saponin-comprising extract is present in an amount ranging from about 250 ppm to about 5,000 ppm.

45. The composition according to claim 44, wherein the at least one saponin-comprising extract is present in an amount ranging from about 250 ppm to about 1,000 ppm.

46. The composition according to claim 43, wherein the at least one saponin-comprising extract is present in an amount ranging from about 100 ppm to about 1,000 ppm.

47. The composition according to claim 45, wherein the at least one saponin-comprising extract is present in an amount ranging from about 250 ppm to about 750 ppm.

48. The composition according to claim 39, wherein the at least one additional preservative is chosen from weak acids and salts thereof, sodium hexametaphosphate, ethylenediaminetetraacetic acid, free fatty acids, esters and derivatives thereof, peptides, lauric arginate, cultured dextrose, neem oil, eugenol, p-cymene, thymol, carvacrol, linalool, hydroxycinnamic acid, cinnamic acid, cinnamic aldehyde, natamycin, tea tree oil, fingerroot extract, acai powder, 4-hydroxybenzyl isothiocyanate and/or white mustard seed essential oil, ferulic acid, and mixtures thereof.

49. The composition according to claim 39, wherein the at least one saponin-comprising extract is derived from soya, beans, peas, oat, Solanum and Allium species, tomato, asparagus, tea, peanut, spinach, sugar beet, yam, blackberry, liquorice root, primula root, senega root, Quillaja, Yucca, Gyposphila, and mixtures thereof.

50. The composition according to claim 49, wherein the at least one saponin-comprising extract is derived from Yucca schidigera, Quillaja saponaria and mixtures thereof.
